(19) United States
(12) Patent Application Publication
(10) Pub. No.: US 2011/0219803 A1
(43) Pub. Date: Sep. 15, 2011

(54) AIR CONDITIONING DEVICE INCLUDING OUTDOOR UNIT AND DISTRIBUTION UNIT

(76) Inventors: Hee PARK, Changwon-si (KR); In Kwon Hwang, Changwon-si (KR); Eun Ho Kim, Changwon-si (KR)

(21) Appl. No.: 13/045,091

(22) Filed: Mar. 10, 2011

(30) Foreign Application Priority Data
Mar. 11, 2010 (KR) 10-2010-0021703
Mar. 11, 2010 (KR) 10-2010-0021706

(51) Int. Cl. F25B 27/00; F25D 17/06; F25D 17/00; F16L 49/00

(52) U.S. Cl. 62/238.6; 62/426; 137/563; 137/798

(57) ABSTRACT

An air conditioning device is provided that includes an outdoor unit and a distribution unit. In the air conditioning device, a length of pipes that connect a plurality of indoor units to the outdoor unit is minimized to improve aesthetic appeal and efficiency, and pipes are arranged in the distribution unit for interconnecting the indoor units and the outdoor unit efficiently so as to minimize the volume of the distribution unit. The distribution unit may have a modular structure such that single or multiple distribution units may be added or removed as needed.

### CROSS-REFERENCE TO RELATED APPLICATION(S)

This application claims the benefit of Korean Patent Application No. 10-2010-0021703, filed in Korea on Mar. 11, 2010 and Korean Patent Application No. 10-2010-0021706, filed in Korea on Mar. 11, 2010, which are hereby incorporated by reference as if fully set forth herein.

### BACKGROUND

1. Field

This relates to an air conditioning device, and more particularly, to an air conditioning device including an outdoor unit and a distribution unit.

2. Background

An air conditioning device may provide cooling to a room by repeatedly performing a series of operations including suctioning indoor air, performing heat exchange between a low-temperature refrigerant and the suctioned indoor air, and discharging the heat-exchanged air into the room, or may provide heating to a room by repeatedly performing these operations in reverse. The air conditioning device employs a series of cycles implemented by a compressor, an outdoor heat exchanger, an expansion valve, and an indoor heat exchanger.

### BRIEF DESCRIPTION OF THE DRAWINGS

The embodiments will be described in detail with reference to the following drawings in which like reference numerals refer to like elements wherein:

FIG. 1 illustrates various exemplary installations of a distribution unit connected to an outdoor unit of an air conditioning device, in accordance with an embodiment as broadly described herein;

FIG. 2 illustrates an exemplary installation in which the distribution unit is mounted in an installation space defined in the outdoor unit;

FIG. 3 is a perspective view of a distribution unit of an air conditioning device, in accordance with an embodiment as broadly described herein;

FIG. 4 is a perspective view of a distribution unit of the air conditioning device in accordance with another embodiment as broadly described herein;

FIG. 5 illustrates a first set of internal pipes of a distribution unit of an air conditioning device, in accordance with an embodiment as broadly described herein;

FIG. 6 illustrates a second set of internal pipes of the distribution unit of the air conditioning device;

FIG. 7 illustrates an assembled state of the first and second sets of internal pipes shown in FIGS. 5 and 6;

FIG. 8 illustrates refrigerant flow between an outdoor unit and a plurality of indoor units via a distribution unit assembly in accordance with an embodiment as broadly described herein;

FIG. 9 is a perspective view of a distribution unit assembly mounted in an outdoor unit of an air conditioning device as embodied and broadly described herein;

FIGS. 10A-10D illustrate a distribution unit assembly in accordance with an embodiment as broadly described herein;

FIGS. 11A-11B are perspective views of pipes provided in a distribution unit module of the distribution unit assembly shown in FIGS. 10A-10D;

FIG. 12 is a perspective view of an assembled state of the pipes shown in FIGS. 11A-11B;

FIGS. 13A-13B are perspective views of another embodiment of the distribution unit assembly as broadly described herein;

FIGS. 14 and 15 illustrate refrigerant flow in a cooling mode of an air conditioning device in accordance with embodiments as broadly described herein; and

FIGS. 16 and 17 illustrate refrigerant flow in a heating mode of an air conditioning device in accordance with embodiments as broadly described herein.

### DETAILED DESCRIPTION

In the following detailed description, reference is made to the accompanying drawing figures which form a part hereof, and which show by way of illustration various embodiments as broadly described herein. Other embodiments may be utilized, and structural, electrical, as well as procedural changes may be made without departing from the scope as broadly described herein. Wherever possible, the same reference numbers will be used throughout the drawings to refer to the same or similar parts.

Air conditioning devices may include various functions in addition to heating and cooling, such as, for example, an air purification function that draws in contaminated indoor air, filters the contaminated air, and resupplies the filtered air into a designated space, and a dehumidification function that dehumidifies humid air and resupplies the dehumidified air into the designated space.

Air conditioning devices may be classified into separate air conditioning devices in which an outdoor unit and an indoor unit of the device are separately installed, integrated air conditioning devices in which an outdoor unit and an indoor unit are installed in an integrated manner, and multi type air conditioning devices in which a plurality of indoor units are connected to a single outdoor unit.

Such a multi type air conditioning device may have an effect equivalent to that obtained by installing a plurality of separate air conditioning devices, each including a single outdoor unit and a single indoor unit, to provide air conditioning to a plurality of designated spaces. An outdoor unit may include an outdoor heat exchanger that performs heat exchange between a refrigerant and air outside an air conditioning space and a compressor. In this structure, refrigerant circulated through the respective indoor units may be collected at a single outdoor unit, and the collected refrigerant may be re-distributed to the respective indoor units through repeatedly performing a compression process and a condensing process (when cooling).

Such multi type air conditioning devices, may allow the number of outdoor units required to air condition a given number of spaces to be reduced. However, the associated piping may be complicated because the respective indoor units are individually connected to the outdoor unit, and the length of these pipes may be relatively long, depending on the number of outdoor units, particularly if the distance between the outdoor units and an air conditioning space increases.

In particular, an outdoor unit of a multi type air conditioning device draws air from one offside, such as, for example, the front or the rear, of the outdoor unit and discharges heat-exchanged air through the of the opposite side, such as, for example, the front or the rear, of the outdoor unit. Consequently, an installation direction of the outdoor unit may be specified for a particular installation space of the outdoor unit. The outdoor unit may include an indoor unit connection part to which refrigerant pipe(s) connected to the indoor units may be connected. A plurality of pipes may be directed to the front or rear of the outdoor unit depending upon the installation direction of the outdoor unit and the relative position of the air conditioning spaces.

If the number of indoor units connected to the outdoor unit is large, the length and volume of pipes connecting the outdoor unit and the indoor units may also be relatively large, which may deteriorate the aesthetics of an installation space. In a case in which the refrigerant pipes extend around the outdoor unit to be connected to the appropriate connection part(s), the refrigerant pipes may be bent, thereby increasing flow resistance and decreasing energy efficiency of the air conditioning device.

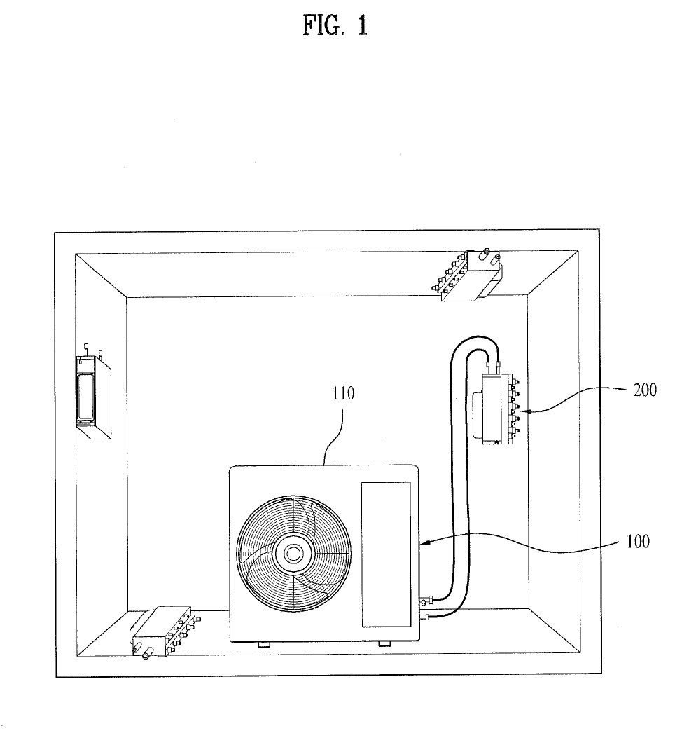

FIG. 1 illustrates various exemplary installations a distribution unit 200 mounted at various installation positions external to an outdoor unit 100 to which the distribution unit 200 is connected.

The distribution unit 200 may be installed at various positions, depending on the position of air conditioning spaces in which one or more indoor units are installed and the direction in which the outdoor unit 100 of the air conditioning device is installed.

The outdoor unit 100 draws in outdoor air, performs heat exchange with the outdoor air, and discharges the heat-exchanged air in a predetermined direction (for example, from an outdoor heat exchanger to a blowing fan). An indoor unit connection part may be provided at a predetermined position in a housing 110 of the outdoor unit 100. The outdoor unit 100 may be connected to the respective indoor units via the distribution unit 200, as shown in FIG. 1, rather than by individual pairs of pipes for each of the indoor units, so that a length of each of the pipes may be reduced in proportion to the distance between the outdoor unit 100 and the distribution unit 200.

It is noted that, if the distance between the installation position of the outdoor unit 100 and the air conditioning spaces in which the respective indoor units are installed is short, the outdoor unit 100 may include an indoor unit connection part having sockets connected to the respective indoor units at a main body thereof. In this case, it may not be efficient to provide a distribution unit at an installation space external to the outdoor unit 100. However, if an outdoor unit of a multi type air conditioning device having a plurality of indoor units connected thereto includes an indoor unit connection part that connects the respective indoor units to the outdoor unit, or a distribution unit connection part connected to the distribution unit, it may be difficult for such an outdoor unit to satisfy various user demands. Thus, an air conditioning device as embodied and broadly described herein may include a distribution unit 200 detachably mounted or embedded in the outdoor unit.

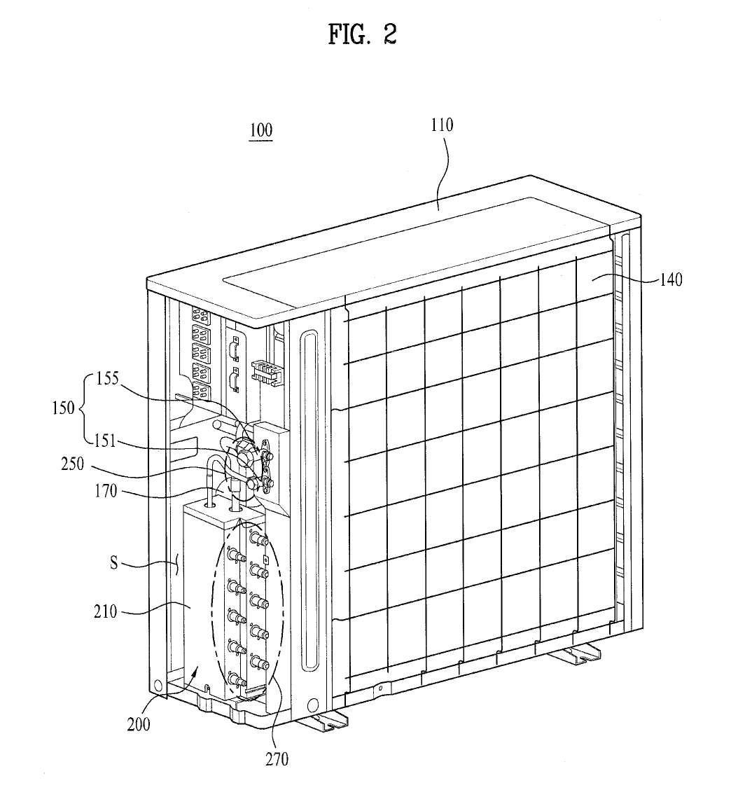

An air conditioning device having a distribution unit as embodied and broadly described herein will now be described in more detail with reference to FIG. 2.

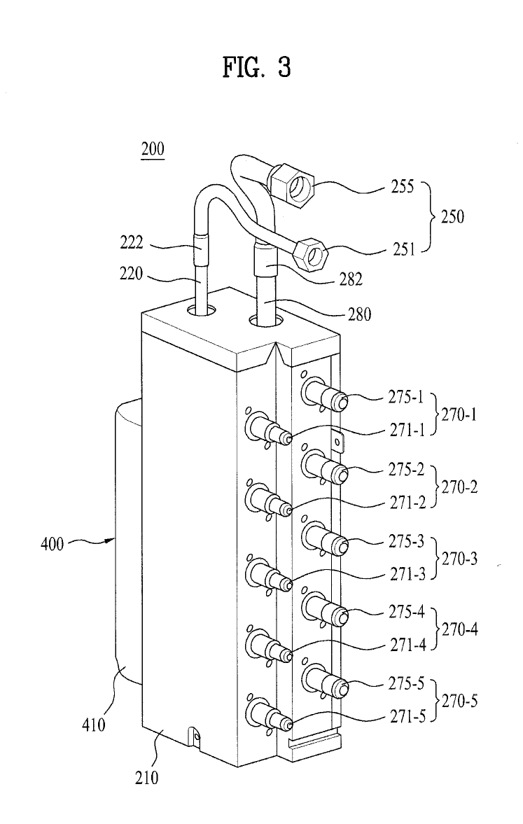

As shown in FIG. 2, the air conditioning device may include an outdoor unit 100 having a compressor 170, an outdoor heat exchanger 140, and at least one distribution unit 200 having at least one indoor unit connection part 270 to be connected to at least one indoor unit, a liquid state refrigerant pipe 220 (see FIG. 3) and a gas state refrigerant pipe 280 (see FIG. 3), and a distribution unit housing 210. The distribution unit 200 may be detachably mounted in the outdoor unit 100 so as to distribute refrigerant from the outdoor unit 100 to one or more indoor units and to guide the refrigerant from the one or more indoor units back to the outdoor unit 100.

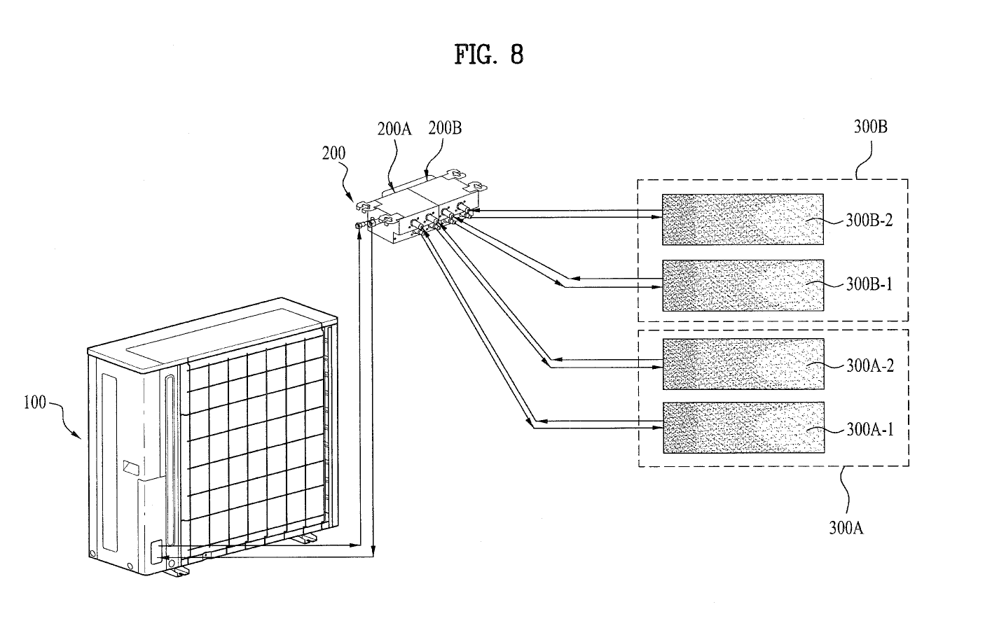

In the embodiment shown in FIGS. 2 to 7, the distribution unit 200 is a single type distribution unit. In other embodiments which will be described with reference to FIGS. 8 to 13, the distribution unit 200 may have a modular structure. In this case, the modular distribution units may together form a distribution unit assembly.

In the embodiment shown in FIG. 2, the distribution unit 200 is mounted in an installation space S defined within the housing 110 of the outdoor unit 100. In contrast, the distribution unit 200 shown in FIG. 1 is installed external to the outdoor unit 100.

A portion, for example, a side, of the outdoor unit housing 110 of the outdoor unit 100 shown in FIG. 2 may be open, with the distribution unit 200 detachably mounted in the outdoor unit 100. The distribution unit 200 may include a plurality of indoor unit connection parts 270 that may be respectively connected to a plurality of indoor units via respective pairs of refrigerant pipes. In a case in which the distribution unit 200 is mounted within the outdoor unit 100, as shown in FIG. 2, the respective indoor unit connection parts 270 may be exposed to the outside.

In alternative embodiments, in a case in which a multi type air conditioning device does not include a separate distribution unit, the outdoor unit 100 itself may be provided with the indoor unit connection parts.

The distribution unit 200 may be provided at one side thereof with the plurality of indoor unit connection parts 270. In addition, the distribution unit 200 may be provided at another side thereof with an outdoor unit connection part 250 connected to the compressor 170 and the outdoor heat exchanger 140 of the outdoor unit 100.

The outdoor heat exchanger 140 may be positioned along an air flow path in the outdoor unit 100 which draws outdoor air into and discharges outdoor air from the internal space of the outdoor unit 100, thus impacting a position of the installation space S within the outdoor unit 100. That is, openings through which outdoor air flows may be formed at the front and rear of the outdoor unit housing 110, and therefore the installation space S may be located at a region where the flow of suctioned air, having passed through the outdoor heat exchanger 140, will not be disrupted by the installation of the distribution unit 200. The compressor 170 may also be installed at a position so as to not disrupt the flow of outdoor air.

For example, the compressor 170 and the outdoor heat exchanger 140 may be installed at an outer edge portion of the outdoor unit housing 110. Thus, a length of the distribution unit housing 210 may be sufficient to accommodate a plurality of indoor unit connection parts 270. Consequently, the installation space S of the distribution unit 200 may be located in the outdoor unit housing 110 in the vicinity of an appropriate side/end of the outdoor unit housing 110. The outdoor unit connection part 250 of the distribution unit 200 may be connected to the outdoor unit 100 such that a length of the pipes connected between the outdoor unit connection part 250 and the compressor 170 of the outdoor heat exchanger 140 may be reduced/minimized.

As shown in FIG. 2, the outdoor unit connection part 250 may be coupled to a pipe connection part 150 of the outdoor unit 100 positioned corresponding to the outdoor unit connection part 250, such as, for example, above the distribution unit 200.

The distribution unit housing 210 may have various shapes, and, in certain embodiments, may be formed in the shape of a long square pillar, with the indoor unit connection parts 270 provided along one longitudinal side of the distribution unit housing 210 such that the indoor unit connection parts 270 can be connected to the respective indoor units. In the embodiment shown in FIG. 3, the distribution unit 200 includes 5 indoor unit connection parts 270-1, 270-2, 270-3, 270-4 and 270-5 that connect the outdoor unit 100 to 5 corresponding indoor units. The number of indoor unit connection parts 270 may be varied depending upon the capacity of the compressor 170 and other such factors. Thus, if the capacity of the compressor 170 is relatively large, the number of indoor unit connection parts 270 (and indoor units to which the outdoor unit 100 is connected) may be increased in proportion thereto.

An auxiliary controller 400 and controller housing 410 may be provided on a side of the distribution unit housing 210 that is opposite a side thereof on which the indoor unit connection parts 270 are located. The auxiliary controller 400 may control an electronic expansion valve provided in the distribution unit 200, and/or other valves provided in the distribution unit 200, depending on required functionality. The auxiliary controller 400 may include an electronic circuit provided in the distribution unit 200 for controlling the electronic expansion valve and/or other valves to adjust the flow rate of a refrigerant or to decompress (or expand) the refrigerant.

Control signals between the outdoor unit and the distribution unit and between the distribution unit and the respective indoor units, even when the outdoor unit is connected to the indoor units via a distribution unit, could be transmitted via communication cables. However, in the air conditioning device as embodied and broadly described herein, the outdoor unit 100 may be directly connected to the respective indoor units so as to transmit and receive control signals therebetween, and the outdoor unit 100 may be connected to the auxiliary controller 400 of the distribution unit 200. Thus, communication cables are not needed for transmission of control signals between the distribution unit 200 and the indoor units.

The distribution unit 200 of the air conditioning device shown in FIGS. 2 and 3 may allow a length of the refrigerant pipe connected between the outdoor unit 100 and the distribution unit 200 to be minimized, thereby reducing installation costs and providing an aesthetically pleasing appearance. Consequently, it may be advantageous to further reduce the length of the refrigerant pipe. However, installation costs of communication cables for performing transmission and reception of control signals are not greatly increased with an increase in length of the cables, unlike the refrigerant pipe. For this reason, it may also be advantageous to minimize connection regions of such cables.

Also, in a system in which a controller for controlling the indoor units is provided in the distribution unit, the volume of the controller is increased, causing the volume of the distribution unit to also be increased and utilization efficiency of the distribution unit to be reduced. In a case in which the distribution unit is mounted outdoors, the distribution unit may also include a structure for preventing intrusion of rainwater or moisture, further increasing the total size of the distribution unit.

Consequently, the auxiliary controller 400 of the distribution unit 200 of the air conditioning device as embodied and broadly described herein may be configured to control only the electronic expansion valve provided in the distribution unit 200.

In a case in which the distribution unit 200 is mounted external to the outdoor unit 100, the controller housing 410 and auxiliary controller 400 may be installed within the distribution unit housing 210. In contrast, in a case in which the distribution unit 200 is installed within the outdoor unit 100, the separate controller housing 41n may be eliminated, because the valves provided in the distribution unit housing 210 may be directly connected to the controller 400. Alternatively, the controller housing 410 may be detachably mounted in the distribution unit housing 210.

In a case in which the controller housing 410 is mounted in the distribution unit 200, communication holes for interconnecting the electronic expansion valve provided in the distribution unit 200 and the auxiliary controller 400 may be located at corresponding positions in the distribution unit housing 210 and the controller housing 410.

A sealing member may be provided between the distribution unit housing 210 and the controller housing 410 for preventing permeation of foreign matter, such as rainwater or moisture, even when the distribution unit 200 is mounted outdoors.

Also, in a case in which the distribution unit 200 is mounted outside the outdoor unit 100, the installation position or the installation direction of the distribution unit 200 may be impacted. For this reason, at least one enlarged pipe section 222 may be provided at the liquid state refrigerant pipe 220 of the distribution unit 200, and at least one enlarged pipe section 282 may be provided at the gas state refrigerant pipe 280 of the distribution unit 200, such that the distribution unit 200 may be flexibly mounted outside the outdoor unit 100.

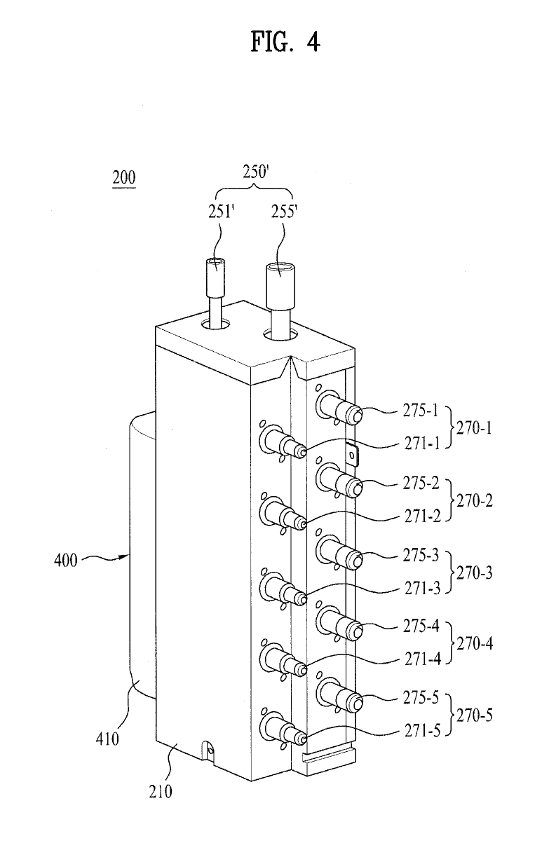

The enlarged pipe sections 222 and 282 of the liquid state refrigerant pipe 220 and the gas state refrigerant pipe 280, respectively, may have enlarged diameters compared to those of the respective refrigerant pipes 220 and 280 and extending outward though the top or bottom of the distribution unit housing 210. The enlarged pipe sections 222 and 282 may couple corresponding refrigerant pipes to the liquid state refrigerant pipe 220 and the gas state refrigerant pipe 280. The enlarged pipe sections 222 and 282 may be provided at portions that extend vertically upward from the top of the distribution unit housing 210, at upper ends of the liquid state refrigerant pipe 220 and the gas state refrigerant pipe 280. Cutting the enlarged pipe portions 222 and 282 to form an outdoor unit connection part will be described with reference to FIG. 4.

In the distribution unit 200 shown in FIG. 3, in order to horizontally interconnect the pipe connection part 150 of the outdoor unit 100 and the outdoor unit connection part 250 of the distribution unit 200, the pipe connection part 150 of the outdoor unit 100 extends horizontally from the refrigerant pipes 220 and 280, and the liquid state refrigerant pipe 220 and the gas state refrigerant pipe 280 are bent such that the outdoor unit connection part 250 is connected to the pipe connection part 150 of the outdoor unit 100 in a corresponding, i.e., horizontal, direction.

This connection structure may be employed in a case in which the distribution unit 200 is mounted in the outdoor unit 100. That is, the liquid state refrigerant pipe 220 and the gas state refrigerant pipe 280 of the distribution unit 200 may be bent such that the outdoor unit connection part 250 provided at the ends of the liquid state refrigerant pipe 220 and the gas state refrigerant pipe 280 is coupled to the pipe connection part 150 of the outdoor unit 100 at a specific position.

FIG. 4 is a perspective view of a distribution unit of the an air conditioning device when viewed in a direction in which indoor unit connection parts are visible, in accordance with another embodiment as broadly described herein.

In a case in which the distribution unit 200 is mounted at a separate installation space, and not in the outdoor unit 100, it may not be necessary for the outdoor unit connection part 250 of the distribution unit 200 to have the bent structure shown in FIG. 3.

That is, in the distribution unit 200 shown in FIG. 4, the enlarged pipe portions of the distribution unit shown in FIG. 3 may form an outdoor unit connection part 250′. The outdoor unit connection part 250′ may be formed by cutting the enlarged pipe sections. An outdoor side high-pressure connection part 251′ and an indoor side high-pressure connection part 255′ may have a pipe structure, the diameters of which are greater than the corresponding portions of the liquid state refrigerant pipe 220 and the gas state refrigerant pipe 280.

In the embodiment shown in FIG. 4, the outdoor unit connection part 250′ does not have a socket shape, as the embodiment shown in FIG. 3 has. Rather, in the embodiment shown in FIG. 4, the refrigerant pipes, through which refrigerant flows between the outdoor unit 100 and the distribution unit 200, may be inserted into the outdoor side high-pressure connection part 251′ and the indoor side high-pressure connection part 255′ that together form the outdoor unit connection part 250′ and welded to the insides of the outdoor side high-pressure connection part 251′ and the indoor side high-pressure connection part 255′.

As described above, the enlarged pipe sections are provided at the respective refrigerant pipes, and the enlarged pipe sections are cut to form the outdoor side high-pressure connection part 251′ and the indoor side high-pressure connection part 255′ as needed, thereby facilitating pipe connection and improving reliability of the connection therebetween.

More specifically, working efficiency and/or reliability of connection regions may be adversely impacted when pipes having similar diameters are connected to each other by welding, without the enlarged pipe sections, as opposed to when pipes are connected to each other by welding one of the pipes inserted in the other pipe.

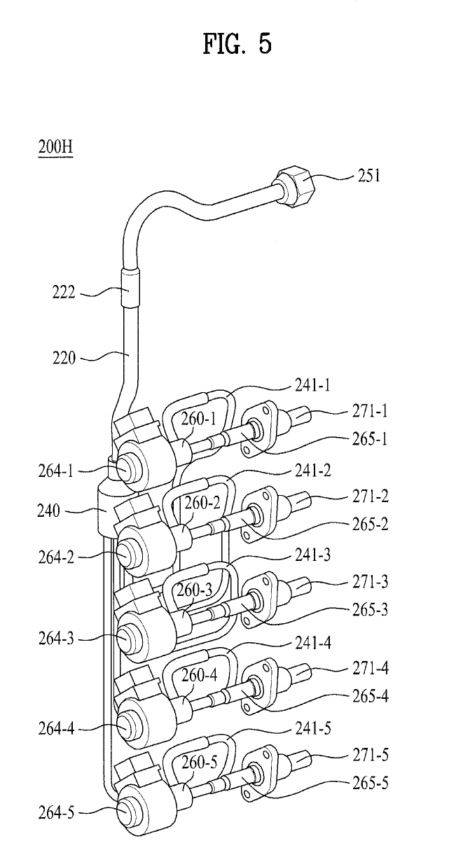

FIG. 5 illustrates some of the internal pipes of the distribution unit of the air conditioning device as embodied and broadly described herein. More specifically, the liquid state refrigerant pipe 220 and associated connections for distributing or decompressing (expanding) refrigerant supplied from the outdoor unit 100 are shown in FIG. 5. Simply for ease of description, an assembly of pipes for distributing or decompressing (expanding) refrigerant supplied from the outdoor unit 100 and for supplying the refrigerant to the indoor units in a cooling mode will be referred to as a high-pressure part 100H, and an assembly of pipes for collecting refrigerant from the indoor units and supplying the collected refrigerant to the outdoor unit 100 in a cooling mode will be referred to as a low-pressure part 200L.

In the high-pressure part 200H as shown in FIG. 5, an outdoor side high-pressure socket 251 is provided at one end of a main refrigerant pipe, i.e., the liquid state refrigerant pipe 220, such that the outdoor side high-pressure socket 251 is coupled to a high-pressure socket 151 of the pipe connection part 150 at the compressor side. A distributor 240 may be provided at an end of the liquid state refrigerant pipe 220 opposite the socket 251. The distributor 240 distributes refrigerant to first through fifth expansion valves 260-1, 260-2, 260-3, 260-4 and 260-5 for decompressing or expanding refrigerant to be respectively supplied to first through fifth indoor unit connection parts 270-1, 270-2, 270-3, 270-4 and 270-5. The distributor 240 includes first through fifth liquid state refrigerant branch pipes 241-1, 241-2, 241-3, 241-4 and 241-5 for guiding refrigerant to the first through fifth expansion valves 260-1, 260-2, 260-3, 260-4, and 260-5, respectively. The first through fifth liquid state refrigerant branch pipes 241-1, 241-2, 241-3, 241-4, and 241-5 branch off from the distributor 240 and are respectively connected to the electronic expansion valves 260-1, 260-2, 260-3, 260-4 and 260-5.

Refrigerant supplied through the first to fifth liquid state refrigerant branch pipes 241-1, 241-2, 241-3, 241-4 and 241-5 is decompressed or expanded by the first to fifth expansion valves 260-1, 260-2, 260-3, 260-4 and 260-5, and is then respectively supplied to first to fifth indoor units 300A, 300B, 300C, 300D and 300E provided in air conditioning spaces 400A, 400B, 400C, 400D and 400E, respectively, via first to fifth indoor side high-pressure sockets 271-1, 271-2, 271-3, 271-4 and 271-5 of the indoor unit connection parts 270-1 through 270-5. The first to fifth indoor side high-pressure sockets 271-1, 271-2, 271-3, 271-4 and 271-5 may be respectively connected to the first to fifth expansion valves 260-1, 260-2, 260-3, 260-4 and 260-5 via first to fifth liquid state refrigerant connection pipes 265-1, 265-2, 265-3, 265-4 and 265-5, respectively.

The first to fifth expansion valves 260-1, 260-2, 260-3, 260-4 and 260-5 may also include first to fifth communication line connection parts 264-1, 264-2, 264-3, 264-4 and 264-5, respectively, such that control signals for controlling the first to fifth expansion valves 260-1, 260-2, 260-3, 260-4 and 260-5 are transmitted to the first to fifth expansion valves 260-1, 260-2, 260-3, 260-4 and 260-5. Control signals provided from the controller 400, provided in the outdoor unit 100, are transmitted to the first to fifth communication line connection parts 264-1, 264-2, 264-3, 264-4 and 264-5 via communication lines for controlling the first to fifth expansion valves 260-1, 260-2, 260-3, 260-4 and 260-5 to adjust the flow rate of refrigerant and to expand (decompress) the refrigerant.

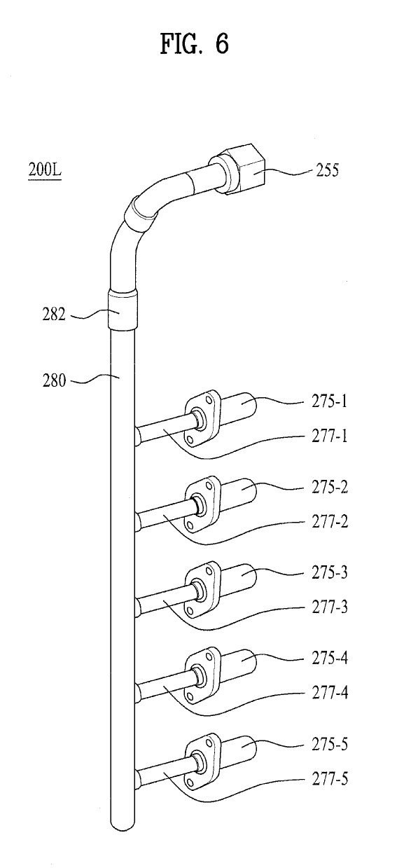

FIG. 6 is a perspective view of the remaining internal pipes of the distribution unit of the air conditioning device as embodied and broadly described herein.

More specifically, the low-pressure part 200L formed by the gas state refrigerant pipe 280 for collecting refrigerant from the indoor units is shown in FIG. 6.

The gas state refrigerant pipe 280 may include a plurality of gas state refrigerant branch pipes 277-1, 277-2, 277-3, 277-4 and 277-5 branching off from the gas state refrigerant pipe 280 to indoor side low-pressure sockets 275-1, 275-2, 275-3, 275-4 and 275-5 of the indoor unit connection parts 270 at predetermined intervals. The indoor unit connection parts 270 are provided at the side of the distribution unit housing 210, and the gas state refrigerant pipe 280 is connected to the indoor unit connection parts 270-1 through 270-5 via the respective gas state refrigerant branch pipes 277-1 through 277-5.

In the low-pressure part 200B as shown in FIG. 6, when refrigerant is collected from the first to fifth indoor units 300A, 300B, 300C, 300D and 300E through the refrigerant pipe via first to fifth indoor side low-pressure sockets 275-1, 275-2, 275-3, 275-4 and 275-5 and first to fifth gas state refrigerant branch pipes 277-1, 277-2, 277-3, 277-4 and 277-5, the gas state refrigerant pipe 280 collects the refrigerant and guides it to an outdoor side low-pressure socket 255. In certain embodiments, the gas state refrigerant pipe 280 does not necessarily include an additional distributor. However, in alternative embodiments, a distributor for connecting the first to fifth gas state refrigerant branch pipes 277-1, 277-2, 277-3, 277-4 and 277-5 to the gas state refrigerant pipe 280 may be provided for performing a heating operation.

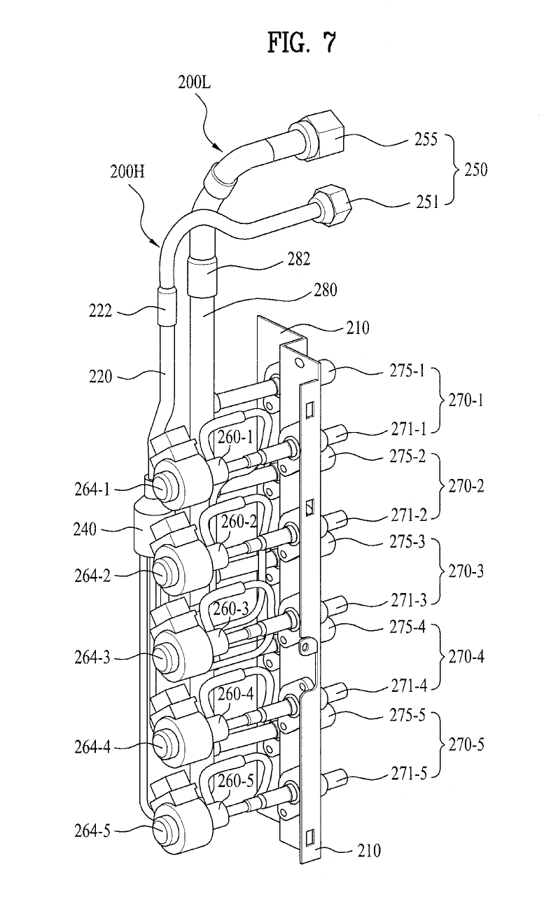

FIG. 7 illustrates an assembled state of the internal pipes of the distribution unit 200 of the air conditioning device shown in FIGS. 2-6, i.e., the high pressure part 200H and the low pressure part 200L. The gas state refrigerant pipe 280 and the liquid state refrigerant pipe 220 are arranged in a longitudinal direction in the distribution unit housing 210, with the outdoor unit connection part 250 provided at corresponding ends of the gas state refrigerant pipe 280 and the liquid state refrigerant pipe 220 extending outward through the top or bottom of the distribution unit housing 210.

The distribution unit 200 may be mounted in an installation space defined in the outdoor unit housing 110 of the outdoor unit 100 or in alternative installation spaces separate from the outdoor unit 100. In a case in which the distribution unit 200 is mounted in the outdoor unit 100, it may be advantageous to minimize the installation space consumed by the distribution unit 200 in the outdoor unit 100.

The installation space of the distribution unit 200 may be located near the side of the outdoor unit housing 110 and/or in the vicinity of the compressor 170. In a case in which an extra space defined in the outdoor unit housing 110 for removing the distribution unit 200 from the outdoor unit housing 110 is provided, a vertical corner space of the outdoor unit housing 110 may be used as the installation space of the distribution unit 200 to minimize any increase in volume due to the installation of the outdoor unit 100. The distribution unit housing 210 may have a long rectangular shape so as to contain the plurality of indoor unit connection parts 270 and the outdoor unit connection part 250, with the respective indoor unit connection parts 270 arranged along the side of the distribution unit housing 210 at predetermined intervals, and the outdoor unit connection part 250 positioned above the distribution unit housing 210, so that the indoor unit connection parts 270 are exposed outside the outdoor unit 100, thereby minimizing the installation space of the distribution unit 200.

Also, as shown in FIGS. 5 to 7, the liquid state refrigerant pipe 220 and the gas state refrigerant pipe 280 are arranged in a longitudinal direction of the distribution unit housing 210 and branch off to the respective indoor unit connection parts 270 provided at the side of the distribution unit housing 210, thereby minimizing the volume of the distribution unit housing 210.

The lower parts of the liquid state refrigerant pipe 220 and the gas state refrigerant pipe 280 that form the high-pressure part 200A and the low-pressure part 200B shown in FIGS. 5 and 6 are disposed in the distribution unit housing 210, and the upper parts of the liquid state refrigerant pipe 220 and the gas state refrigerant pipe 280 extend out through the top of the distribution unit housing 210. The enlarged pipe sections 222 and 282 may be provided at specific portions of the parts of the liquid state refrigerant pipe 220 and the gas state refrigerant pipe 280 that extend outward, substantially perpendicular to the distribution unit housing 210.

The outdoor side high-pressure socket 251 and the outdoor side low-pressure socket 255 that form the outdoor unit connection part 250 are provided at the ends of the liquid state refrigerant pipe 220 and the gas state refrigerant pipe 280 extending outward from the distribution unit housing 210 such that the outdoor side high-pressure socket 251 and the outdoor side low-pressure socket 255 are connected to the high-pressure socket 151 and the low-pressure socket 155 of the pipe connection part 150.

A refrigerant that has been decompressed or expanded by the first to fifth expansion valves 260-1, 260-2, 260-3, 260-4 and 260-5 may be supplied to the respective indoor units via the first to fifth indoor side high-pressure sockets 271-1, 271-2, 271-3, 271-4 and 271-5 of the first to fifth indoor unit connection parts 270-1, 270-2, 270-3, 270-4 and 270-5, respectively.

The portions of the liquid state refrigerant pipe 220 and the gas state refrigerant pipe 280 that extend beyond the enlarged pipe sections 222 and 282 may be bent such that the outdoor side high-pressure socket 251 and the outdoor side low-pressure socket 255 that form the outdoor unit connection part 250 are positioned at different heights and are spaced apart from each other. That is, the height of the outdoor side high-pressure socket 251 may be different from that of the outdoor side low-pressure socket 255.

When the high-pressure socket 151 and the low-pressure socket 155 that form the pipe connection part 150 are vertically arranged in a line, the outdoor unit connection part 250 may be horizontally coupled to the pipe connection part 150. That is, the high-pressure socket 151 and the low-pressure socket 155 may be horizontally coupled to the outdoor side high-pressure socket 251 and the outdoor side low-pressure socket 255, respectively. Also, the respective sockets forming the outdoor unit connection part 250 and the pipe connection part 150 may be vertically arranged, thereby reducing the overall size of the outdoor unit.

The first to fifth indoor unit connection parts 270-1, 270-2, 270-3, 270-4 and 270-5 and the outdoor unit connection part 250 may be arranged so that the connections are made horizontally, thereby improving ease of assembly. If the pipes were connected in a vertical direction, it would be necessary to secure vertical assembly tolerance for easy assembly. However, when the liquid state refrigerant pipe 220 and the gas state refrigerant pipe 280 are bent such that the outdoor unit connection part 250 is connected to the pipe connection part 150 in a horizontal direction, it is possible to achieve convenient assembly with tolerance due to elastic deformation of the materials for the liquid state refrigerant pipe 220 and the gas state refrigerant pipe 280 even with a relatively small design tolerance.

The liquid state refrigerant pipe 220 and the gas state refrigerant pipe 280 may extend outward though the top or bottom of the distribution unit housing 210 and may be bent in a direction that is different from the longitudinal direction of the distribution unit housing 210. The enlarged pipe sections 222 and 282 may be located between the bent portions of the liquid state refrigerant pipe 220 and the gas state refrigerant pipe 280 and the distribution unit housing 210.

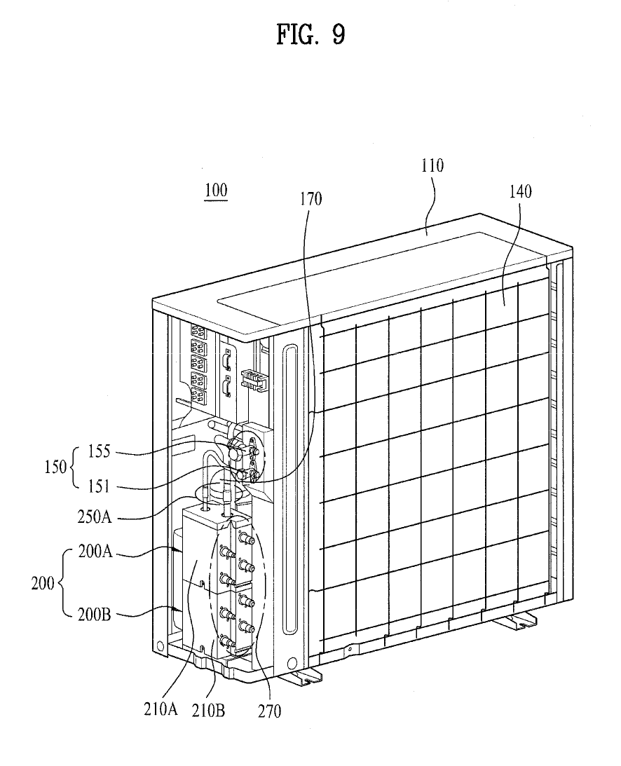

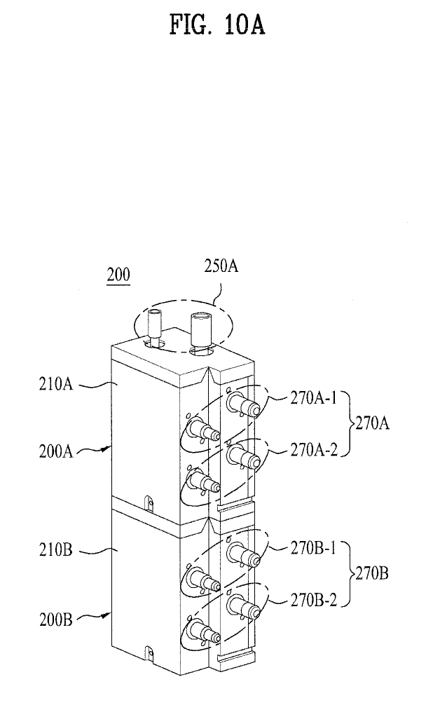

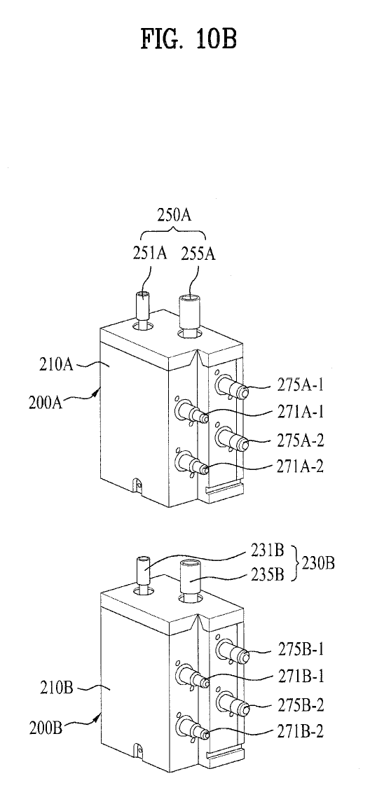

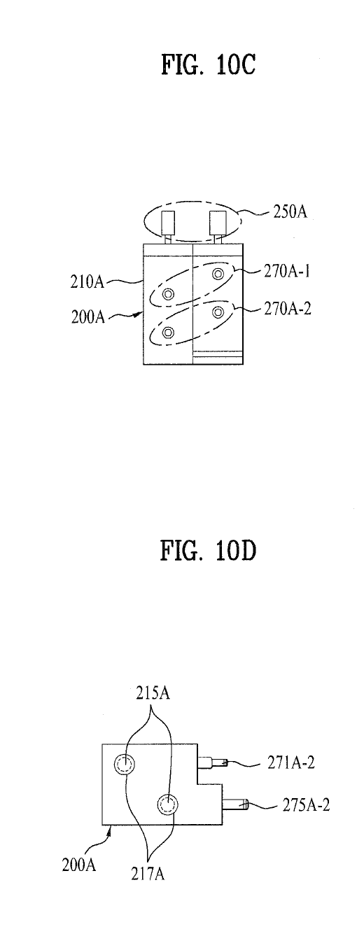

A distribution unit assembly 200 as embodied and broadly described herein may include a basic distribution unit module 200A (see FIG. 10) having an indoor unit connection part 270A (see FIG. 10) connected to at least one indoor unit 300A (see FIG. 8) of the air conditioning device, an outdoor unit connection part 250A (see FIG. 9) connected to an outdoor unit 100 (see FIG. 9) of the air conditioning device, and a distribution unit housing 210A (see FIG. 10) forming the external appearance of the basic distribution unit module 200A and at least one additional distribution unit module 200B (see FIG. 10) having an indoor unit connection part 270B (see FIG. 10) connected to at least one indoor unit 300B (see FIG. 8) of the air conditioning device, a distribution unit connection part 230B (see FIG. 10) connected to the basic distribution unit module 200A, and a distribution unit housing 210B (see FIG. 10) forming the external appearance of the additional distribution unit module 200B.

Hereinafter, an embodiment in which distribution units are connected to each other in a modular structure to form a distribution unit assembly will be described in detail with reference to FIGS. 8 to 13. In this embodiment, at least two distribution units may be operably coupled to form a distribution unit assembly.

FIG. 8 is a conceptual illustration of refrigerant flow between an outdoor unit and a plurality of indoor units via a distribution unit assembly in accordance another embodiment of the air conditioning device as broadly described herein.

As shown in FIG. 8, the distribution unit assembly 200 connects the outdoor unit 100 to one or more indoor units 300A-1, 300A-2, 300B-1 and 300B-2 for distributing refrigerant from the outdoor unit 100 to the indoor units 300A-1, 300A-2, 300B-1 and 300B-2 and for supplying refrigerant collected from the indoor units 300A-1, 300A-2, 300B-1 and 300B-2 back to the outdoor unit 100. In FIG. 8, arrows indicate the flow of refrigerant transmitted via the distribution unit assembly 200.

The indoor units 300A-1, 300A-2, 300B-1 and 300B-2 may be divided into two groups, i.e., indoor units 300A and indoor units 300B. For ease of discussion, indoor units 300A may correspond to units installed when the air conditioning device was initially installed. For this reason, the indoor units 300A will be hereinafter referred to as basic indoor units. Indoor units 300B may correspond to units that are added later, according to user demand. For this reason, the indoor units 300B will be hereinafter referred to as additional indoor units.

The distribution unit assembly 200 connected to the basic indoor units 300A and the additional indoor units 300B may include two distribution unit modules coupled to each other in a stacked structure to constitute the distribution unit assembly 200. More specifically, the distribution unit assembly 200 may include a first distribution unit module 200A connected to the basic indoor units 300A and to the outdoor unit 100 and a second distribution unit module 200B connected to the additional indoor units 300B and to the first distribution unit module 200A.

The distribution unit module 200A is connected to the basic indoor units 300A and, in addition, is directly connected to the outdoor unit 100. That is, the distribution unit module 200A directly receives refrigerant from the outdoor unit 100, distributes the received refrigerant to the basic indoor units 300A, collects refrigerant from the basic indoor units 300A, and supplies the collected refrigerant back to the outdoor unit 100. For this reason, the distribution unit module 200A will be hereinafter referred to as a basic distribution unit module 200A.

On the other hand, the distribution unit module 200B is connected to the additional indoor units 300B and, in addition, to one end of the basic distribution unit module 200A. The distribution unit module 200B does not directly receive or supply refrigerant from or to the outdoor unit 100, but rather, receives or supplies refrigerant between the additional indoor units 300B and the outdoor unit 100 via the basic distribution unit module 200A. For this reason, the distribution unit module 200B will be hereinafter referred to as an additional distribution unit module 200B.

Hereinafter, the flow of refrigerant will be described in detail on the assumption that the air conditioning device includes both the basic distribution unit module 200A and the additional distribution unit module 200B.

First, an initial state in which a multi type air conditioning device is purchased and installed is assumed. In this case, the air conditioning device includes an outdoor unit 100, basic indoor units 300A-1 and 300A-2, and a basic distribution unit module 200A connected between the outdoor unit 100 and the basic indoor units 300A. If an additional distribution unit module 200B is not initially provided in the air conditioning device, refrigerant supplied from the outdoor unit 100 is transmitted to the respective basic indoor units 300A-1 and 300A-2 via the basic distribution unit module 200A, heat exchanged in the respective basic indoor units 300A-1 and 300A-2, and collected in the outdoor unit 100 via the basic distribution unit module 200A, thereby achieving circulation of refrigerant through the system.

If, for example, two indoor units are added to the air conditioning device having the above construction at a later time, i.e., additional indoor units 300B-1 and 300B-2 may be added to the air conditioning device. In this case, as shown in FIG. 8, another distribution unit module, i.e., the additional distribution unit module 200B, may be added to accommodate the two additional indoor units 300B-1 and 300B-2, since only two indoor units 300A-1 and 300A-2 are connected to the basic distribution unit module 200A. The additional distribution unit module 200B connected to the additional indoor units 300B may be detachably coupled to the basic distribution unit module 200A.

When the additional distribution unit module 200B is coupled to the basic distribution unit module 200A as described above, refrigerant supplied from the outdoor unit 100 is distributed to the respective basic indoor units 300A-1 and 300A-2 via the basic distribution unit module 200A or is transmitted to the additional distribution unit module 200B connected to the basic distribution unit module 200A for distribution to the additional indoor units 300B-1 and 300B-2 connected to the additional distribution unit module 200B.

The refrigerant, heat-exchanged by the respective indoor units 300A-1, 300A-2, 300B-1 and 300B-2, is then collected and returned to the outdoor unit 100. Specifically, the refrigerant from the basic indoor units 300A is returned back to the basic distribution unit module 200A, and the refrigerant from the additional indoor units 300B is returned back to the additional distribution unit module 200B. The refrigerant collected in the additional distribution unit module 200B is transmitted to the basic distribution unit module 200A, is mixed with the refrigerant returned to the basic distribution unit module 200A from the basic indoor units 300A, and the mixture of refrigerant is returned to the outdoor unit 100, thereby achieving circulation of a refrigerant.

In the embodiment shown in FIG. 8, the distribution unit assembly 200 is located outside the outdoor unit 100. In an alternative embodiment, the distribution unit assembly 200 may be detachably mounted in an installation space defined in the outdoor unit 100. Hereinafter, the distribution unit assembly 200 mounted in the outdoor unit 100 will be described with reference to FIG. 9.

The construction of the outdoor unit 100 and the installation position of the distribution unit assembly 200 shown in FIG. 9 are essentially the same as those shown in FIG. 2, and therefore, further description thereof will not be provided.

As shown in FIG. 9, a portion (for example, a side portion) of the outdoor unit housing 110 of the outdoor unit 100 may be opened or separated so as to selectively install or remove the distribution unit assembly 200 in or from the outdoor unit 100. The distribution unit assembly 200 includes a plurality of indoor unit connection parts 270 which may each be connected to a respective indoor unit 300 (see FIG. 8) via refrigerant pipes. The distribution unit assembly 200 may also include an outdoor unit connection part 250 connected to the compressor 170 and the outdoor heat exchanger 140.

As shown in FIG. 9, the distribution unit assembly 200 according to this embodiment includes a basic distribution unit module 200A and an additional distribution unit module 200B, which are coupled to each other in a stacked structure to form the distribution unit assembly 200. The basic distribution unit module 200A and the additional distribution unit module 200B may be stacked such that the side of the distribution unit housing 210 where the indoor unit connection parts 270A (see FIG. 10) of the basic distribution unit module 200A are provided and the side of the distribution unit housing 210 where the indoor unit connection parts 270B (see FIG. 10) of the additional distribution unit module 200B are provided form the same plane. That is, the distribution unit module 200A and the additional distribution unit module 200B may be positioned such that the indoor unit connection parts 270A of the basic distribution unit module 200A and the indoor unit connection parts 270B of the additional distribution unit module 200B are all directed toward the same side, such as, for example, the rear, of the outdoor unit 100.

The basic distribution unit module 200A is directly connected to the outdoor unit 100, and therefore may include an outdoor connection part 250A. The outdoor unit 100 may include a pipe connection part 150 connected to the distribution unit assembly 200. As shown in FIG. 9, the outdoor connection part 250A of the basic distribution unit module 200A and the pipe connection part 150 of the outdoor unit 100 may be coupled to each other above the basic distribution unit module 200A. In this coupling structure, the outdoor connection part 250A may be positioned above the basic distribution unit module 200A.

Hereinafter, the structure of the distribution unit assembly 200 will be described in detail with reference to FIG. 10. Simply for ease of description, the titles of sockets and the like will be referred to based on a cooling operation of the air conditioning device. FIG. 10A is a perspective view of the distribution unit assembly in an assembled state. FIG. 10B is a perspective view of the distribution unit assembly in a divided state. FIG. 10C is a right side view and FIG. 10D is a bottom view of a distribution unit module of the distribution unit assembly.

As shown in FIG. 10A, the distribution unit assembly 200 may include the basic distribution unit module 200A directly connected to the outdoor unit 100 and the additional distribution unit module 200B detachably coupled to the basic distribution unit module 200A.

The basic distribution unit module 200A is connected to the outdoor unit 100, basic indoor units 300A, and the additional distribution unit module 200B so as to receive refrigerant from the outdoor unit 100, distribute the refrigerant to the basic indoor units 300A and the additional distribution unit module 200B, receive refrigerant from the basic indoor units 300A and the additional distribution unit module 200B, and return the collected refrigerant back to the outdoor unit 100.

The additional distribution unit module 200B is connected to the basic distribution unit module 200A and to additional indoor units 300B. Consequently, the additional distribution unit module 200B receives refrigerant from the outdoor unit 100 via the basic distribution unit module 200A and distributes the refrigerant to the additional indoor units 300B, and receives refrigerant from the additional indoor units 300B and transmits the collected refrigerant back to the basic distribution unit module 200A for return to the outdoor unit 100.

The basic distribution unit housing 210A and the additional distribution unit housing 210B may also be coupled to each other in a stacked structure such that the distribution unit assembly 200 has a substantially rectangular parallelepiped shape which is long in the vertical direction thereof. The respective indoor unit connection parts 270A-1 and 270A-2 of the basic distribution unit module 200A and the respective indoor unit connection parts 270B-1 and 270B-2 of the additional distribution unit module 200B may be provided at corresponding sides of the distribution unit housings 210A and 210B, and the respective indoor unit connection parts 270A-1 and 270A-2 of the basic distribution unit module 200A and the respective indoor unit connection parts 270B-1 and 270B-2 of the additional distribution unit module 200B may arranged at predetermined intervals in the longitudinal direction thereof.

As shown in FIG. 12, the basic distribution unit module 200A may also include an additional connection part 290A connected to the additional distribution unit module 200B.

The outdoor unit connection part 250A may be exposed from the top of the basic distribution unit housing 210A, and the indoor unit connection parts 270A may be exposed through one of the lateral sides of the basic distribution unit housing 210A (in FIGS. 10A and 10B, the right side). The indoor unit connection parts 270A include a first indoor unit connection part 270A-1 and a second indoor unit connection part 270A-2 so that the indoor unit connection parts 270A may be connected to two indoor units 300A-1 and 300A-2. The first and second indoor unit connection parts 270A-1 and 270A-2 may include indoor side high-pressure sockets 271A-1 and 271A-2 and indoor side low-pressure sockets 275A-1 and 275A-2, respectively.

The additional distribution unit module 200B includes the additional distribution unit housing 210B, a distribution unit connection part 230B to be connected to the basic distribution unit module 200A, and indoor unit connection parts 270B to be connected to the additional indoor units 300B.

In this exemplary embodiment, a single additional distribution unit module 200B is connected to the basic distribution unit module 200A. In alternative embodiments, one or more additional distribution unit modules 200B may be further provided whenever more indoor units to be connected to the outdoor unit 100 are added. Consequently, the additional distribution unit module 200B may also include the additional connection part 290B to be connected to another additional distribution unit module.

The distribution unit connection part 230B may be exposed from the top of the additional distribution unit housing 210B, and the indoor unit connection parts 270B may be exposed from a lateral side, such as the right side, of the additional distribution unit housing 210B. In the same manner as the basic distribution unit module 200A, the respective indoor unit connection parts 270B-1 and 270B-2 may include indoor side high-pressure sockets 271B-1 and 271B-2 and indoor side low-pressure sockets 275B-1 and 275B-2, respectively.

As shown in FIG. 10C, the additional connection part 290A of the basic distribution unit module 200A is not exposed to the outside but may instead be provided inside the basic distribution unit housing 210A. In the same manner, the additional connection part 290B of the additional distribution unit module 200B may be provided inside the additional distribution unit module 200B. Since the additional connection part 290A of the basic distribution unit module 200A is provided in the basic distribution unit housing 210A, and the distribution unit connection part 230B of the additional distribution unit module 200B is exposed outside the additional distribution unit housing 210B, as described above, the basic distribution unit module 200A and the additional distribution unit module 200B may be coupled to each other in a tight contact manner with little to no gap formed between the two distribution unit housings 210A and 210B when the basic distribution unit module 200A and the additional distribution unit module 200B are coupled to each other in a stacked structure. That is, the distribution unit connection part 230B, which is exposed to the outside, is connected to the additional connection part 290A, which is provided in the basic distribution unit housing 210A, allowing the basic distribution unit module 200A and the additional distribution unit module 200B to be connected in series to each other such that the bottom of the basic distribution unit housing 210A is in tight contact with the top of the additional distribution unit housing 210B.

In this embodiment, the basic distribution unit module 200A and the additional distribution unit module 200B are coupled to each other in a stacked structure. Even when a plurality of additional distribution unit modules 200B are added, this type of coupling may be applied to the added additional distribution unit modules 200B if the additional distribution unit modules 200B have the same structure and the same shape.

However, determination as to whether the outdoor unit connection part 250A, the additional connection part 290A, the distribution unit connection part 230B, and the additional connection part 290B are exposed outward from the distribution unit housing or provided in the distribution unit housing is not particularly restricted. For example, if the outdoor unit connection part 250A, the additional connection part 290A, the distribution unit connection part 230B, and the additional connection part 290B are all exposed outward from the top and bottom of the respective distribution unit housing, when the basic distribution unit module 200A and the additional distribution unit module 200B are connected to each other in a stacked structure or when the additional distribution unit modules 200B are connected to each other in a stacked structure, it is still possible to achieve smooth connection between the modules with little to no gap formed therebetween by the provision of ribs having a predetermined height at the edges of the top and bottom of the distribution unit housing(s) such that the ribs extend in the longitudinal direction of the distribution unit housing(s).

As shown in FIG. 10D, the basic distribution unit housing 210A may be provided at the bottom thereof with connection part insertion holes 215A, through which the distribution unit connection part 230B is inserted into the basic distribution unit housing 210A to be connected to the additional connection part 290A. The additional distribution unit housing 210B may also be provided at the bottom thereof with connection part insertion holes, through which a distribution unit connection part of another additional distribution unit module may be inserted.

In a case in which additional indoor units 300B are not provided, i.e., an additional distribution unit module 200B is not provided, penetration of external foreign manner into the basic distribution unit housing 210A may be prevented by closing the connection part insertion holes 215A using blocking members 217A, such as rubber packing and the like. In the same manner, the connection part insertion holes of any additional distribution unit(s) may also be closed by similar blocking members.

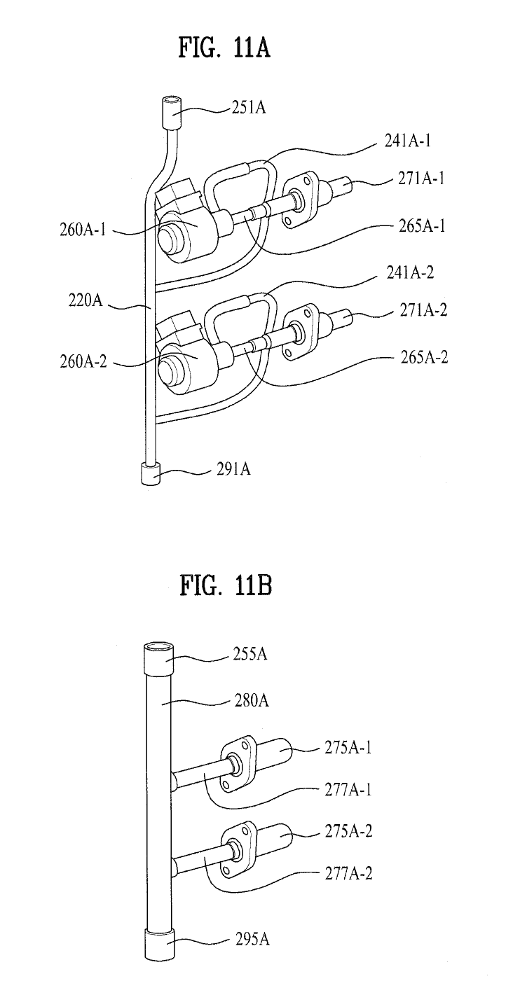

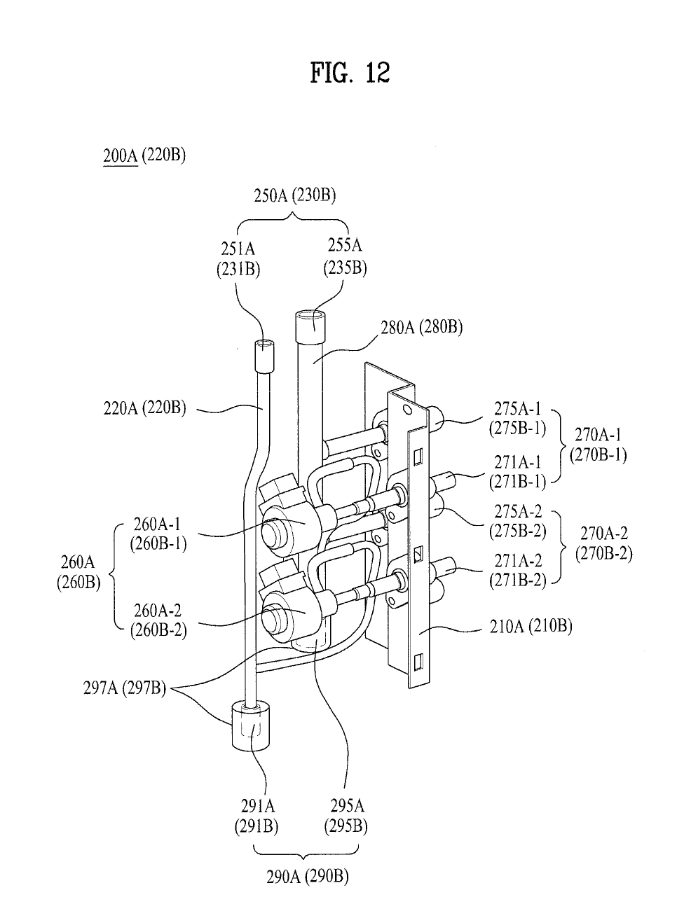

A pipe structure in the basic distribution unit module 200A will now be described in detail with reference to FIGS. 11A-111B. The pipe structure of the basic distribution unit module 200A is similar to that of the additional distribution unit module 200B. Therefore, a separate description of the pipe structure of the additional distribution unit module 200B will not be given.

FIGS. 11A and 11B are perspective views of pipes provided in a distribution unit module as embodied and broadly described herein, segregated according to properties of a refrigerant flowing therethrough. More specifically, FIG. 11A shows pipes mainly including a liquid state refrigerant pipe for distributing or decompressing (expanding) a refrigerant supplied from the outdoor unit 100. For ease of description, an assembly of pipes for distributing or decompressing (expanding) a refrigerant supplied from the outdoor unit 100 and supplying the refrigerant to the indoor units in a cooling mode will be referred to as a high-pressure part, and an assembly of pipes for collecting a refrigerant from the indoor units and supplying the collected refrigerant to the outdoor unit 100 will be referred to as a low-pressure part.

As shown in FIG. 11A, an outdoor side high-pressure socket 251A is provided at one end of a main refrigerant pipe, i.e., a liquid state refrigerant pipe 220A, such that the outdoor side high-pressure socket 251A is coupled to the high-pressure socket 151 of the pipe connection part 150 at the compressor side (see FIG. 9).

An additional distribution unit module high-pressure socket 291A connected to a distribution unit high-pressure socket 231B (see FIG. 10B) of the distribution unit connection part 230B of the additional distribution unit module 200B is provided at the other end of the liquid state refrigerant pipe 220A.

First and second electronic expansion valves 260A-1 and 260A-2 may be provided at the side of the liquid state refrigerant pipe 220A for decompressing or expanding a refrigerant to be supplied to the respective indoor unit connection parts 270A and 270B. The liquid state refrigerant pipe 220A may include a plurality of liquid state refrigerant branch pipes 241A-1 and 241A-2 branching off from the liquid state refrigerant pipe 220A and connected to the electronic expansion valves 260A-1 and 260A-2 at predetermined intervals. Thus, when refrigerant is supplied from the high-pressure socket 151 of the outdoor unit 100 via the outdoor side high-pressure socket 251A, the refrigerant may be supplied to the first and second liquid state refrigerant branch pipes 241A-1 and 241A-2 via the liquid state refrigerant pipe 220A, or to the additional distribution unit module 200B via the additional distribution unit module high-pressure socket 291A.

The refrigerant, supplied via the first and second liquid state refrigerant branch pipes 241A-1 and 241A-2, may be decompressed or expanded by the first and second electronic expansion valves 260A-1 and 260A-2, and may be supplied to the first and second indoor units 300A-1 and 300A-2, provided in the respective air conditioning spaces, via the first and second indoor side high-pressure sockets 271A-1 and 271A-2 constituting the indoor unit connection parts 270A.

The first electronic expansion valve 260A-1 may include at one end thereof a first liquid state refrigerant connection pipe 265A-1 connected between the first indoor side high-pressure socket 271A-1 and the first electronic expansion valve 260A-1. The second electronic expansion valve 260A-2 may include at one end thereof a second liquid state refrigerant connection pipe 265A-2 connected between the second indoor side high-pressure socket 271A-2 and the second electronic expansion valve 260A-2. The first and second electronic expansion valves 260A-1 and 260A-2 may be controlled by a controller that adjusts the flow rate of refrigerant and expands (decompresses) the refrigerant according to a control command from the controller.

FIG. 11B shows a low-pressure part including a gas state refrigerant pipe for collecting refrigerant from the indoor units. As shown in FIG. 11B, an outdoor side low-pressure socket 255A is provided at one end of the gas state refrigerant pipe 280A such that the outdoor side low-pressure socket 255A is coupled to the low-pressure socket 155 of the pipe connection part 150 at the compressor side. An additional distribution unit module low-pressure socket 295A connected to a distribution unit low-pressure socket 235B of the distribution unit connection part 230B of the additional distribution unit module 200B (see FIG. 10B) is provided at the other end of the gas state refrigerant pipe 280A.

A plurality of gas state refrigerant branch pipes 277A-1 and 277A-2 may branch off from the gas state refrigerant pipe 280A and extend to the indoor side low-pressure sockets 275A-1 and 275A-2 of the indoor unit connection parts 270A at predetermined intervals. That is, the first and second gas state refrigerant branch pipes 277A-1 and 277A-2 may be connected between the indoor side low-pressure sockets 275A-1 and 275A-2 and the gas state refrigerant pipe 280A.

In the gas state refrigerant pipe 280A shown in FIG. 11B, when refrigerant is collected from the first and second indoor units 300A-1 and 300A-2, provided in the respective air conditioning spaces, through the refrigerant pipe via the first and second indoor side low-pressure sockets 275A-1 and 275A-2 and the first and second gas state refrigerant branch pipes 277A-1 and 277A-2, and refrigerant is collected from the additional distribution unit module 200B via the additional distribution unit module low-pressure socket 295A, the gas state refrigerant pipe 280 directs the collected refrigerant to the outdoor side low-pressure socket 255A.

In a case in which no additional distribution unit module 200B is coupled to the basic distribution unit module 200A, the connection part insertion holes 215A may be closed using blocking members 297A (see FIG. 12), such as caps. Because the additional distribution unit module high-pressure socket 291A and the additional distribution unit module low-pressure socket 295A are open to allow for refrigerant transmission, refrigerant may leak from the additional distribution unit module high-pressure socket 291A and the additional distribution unit module low-pressure socket 295A without these sealing measures.

In a similar manner, the additional connection part 290B of the additional distribution unit module 200B may be selectively opened and closed by blocking members 297B (see FIG. 12), such as caps, if another additional distribution unit module 200B is not further connected to the additional connection part 290B.

In the above description of the embodiment shown in FIGS. 11A and 11B, the refrigerant pipes were discussed with respect to the basic distribution unit module 200A. That is, the basic distribution unit module 200A receives refrigerant from the outdoor unit 100 and transmits the refrigerant to the outdoor units 300A and the additional distribution unit module 200B. In addition, the basic distribution unit module 200A collects refrigerant from the indoor units 300A and the additional distribution unit module 200B and supplies the collected refrigerant back to the outdoor unit 100. The refrigerant pipe structure of the additional distribution unit module 200B is similar to that of the basic distribution unit module 200A, except that the additional distribution unit module 200B receives refrigerant from the basic distribution unit module 200A, and not directly from the outdoor unit 100, and the additional distribution unit module 200B transmits refrigerant to the basic distribution unit module 200A. Thus, further detailed description thereof will not be provided.

Hereinafter, the pipe structure in the basic distribution unit module 200A will be described in detail with reference to FIG. 12. As set forth above, the pipe structure of the additional distribution unit module 200B is essentially the same as that of the basic distribution unit module 200A. Therefore, reference numerals of the corresponding pipe elements of the additional distribution unit module 200B are provided in parentheses after those of the basic distribution unit module 200A in FIG. 12.

FIG. 12 is a perspective view of an assembled state of the pipes provided in a distribution unit module as embodied and broadly described herein.

The gas state refrigerant pipe 280A and the liquid state refrigerant pipe 220A may be arranged in the basic distribution unit housing 210A in the longitudinal direction of the basic distribution unit housing 210A. The outdoor unit connection part 250A may be provided at the ends of the gas state refrigerant pipe 280A and the liquid state refrigerant pipe 220A, which extends outward through the top or bottom of the basic distribution unit housing 210A. The additional connection part 290A may be provided within the basic distribution unit housing 210A. In alternative embodiments, the positions of the outdoor unit connection part 250A and the additional connection part 290A outside of or within the basic distribution unit housing 210A as appropriate for a particular application.

The high-pressure part including the liquid state refrigerant pipe 220A and the low-pressure part including the gas state refrigerant pipe 280A are disposed adjacent to each other so as to minimize the volume of the basic distribution unit housing 210A.

The outdoor side high-pressure socket 251A and the outdoor side low-pressure socket 255A forming the outdoor unit connection part 250A are respectively connected to the high-pressure socket 151 and the low-pressure socket 155 of the outdoor unit 100. The additional distribution unit module high-pressure socket 291A and the additional distribution unit module low-pressure socket 295A that form the additional connection part 290A may be respectively connected to the distribution unit high-pressure socket 231B and the distribution unit low-pressure socket 235B of the distribution unit connection part 230B of the additional distribution unit module 200B.

In a similar manner, the additional distribution unit module high-pressure socket 291 B and the additional distribution unit module low-pressure socket 295B of the additional connection part 290B of the additional distribution unit module 200B may be respectively connected to the distribution unit high-pressure socket 231B and the distribution unit low-pressure socket 235B of the distribution unit connection part 230B.

At least one of the outdoor unit connection part 250A, the additional connection part 290A, the distribution unit connection part 230B, or the additional connection part 290B may have an enlarged pipe section that extends from the refrigerant pipe, the inner diameter of which is larger than the other portions of the refrigerant pipe. In a case in which any one of the connection parts has the enlarged pipe section as described above, a corresponding one of the remaining connection parts can be easily inserted into the enlarged pipe section of the connection parts, thereby facilitating coupling between the respective distribution unit modules.

In the embodiment as described above, the distribution unit assembly 200 includes the basic distribution unit module 200A and one or more additional distribution unit modules 200B which may be detachably coupled to the basic distribution unit module 200A, wherein a plurality of additional distribution unit modules further included based on requirements of a particular installation site.

Also, in this exemplary embodiment, each of the distribution unit modules of the distribution unit assembly 200 is connected to two indoor units. However, the number of indoor units connectable to each of the distribution unit modules may be varied based on the requirements of a particular installation.

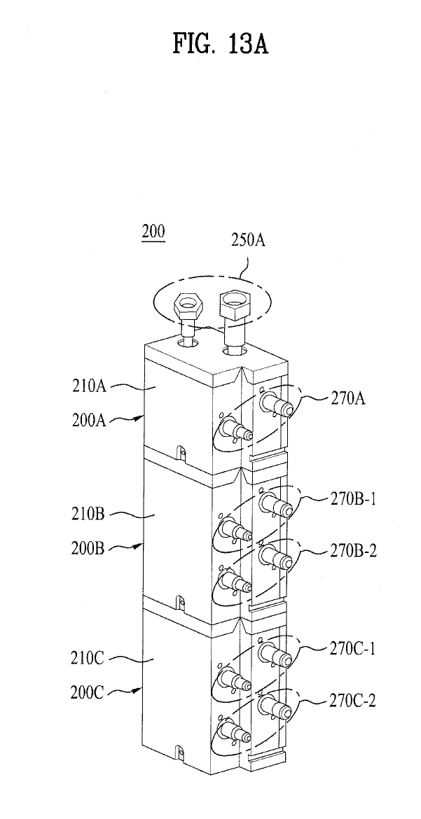

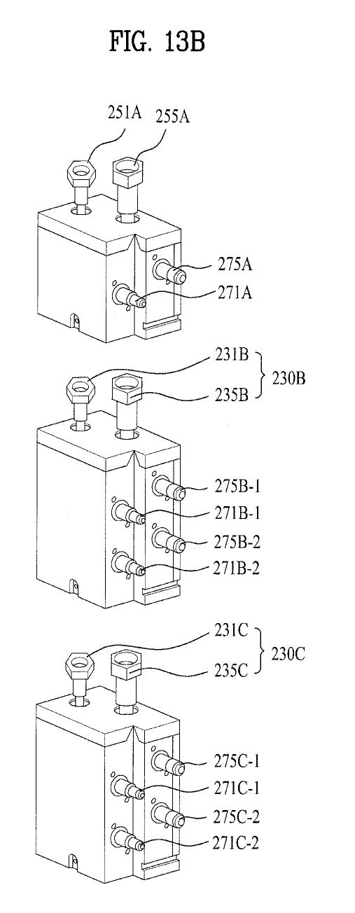

A modification of the distribution unit assembly in accordance with another embodiment will be described in detail with reference to FIGS. 13A and 13B.

FIG. 13A is a perspective view of distribution unit assembly in an assembled state, and FIG. 13B is a perspective view of the distribution unit assembly in a divided state.

As shown in FIG. 13A, the distribution unit assembly 200 according to this embodiment includes a basic distribution unit module 200A, an additional distribution unit module 200B (hereinafter, a first additional distribution unit module 200B) detachably connected to the basic distribution unit module 200A, and another additional distribution unit module 200C (hereinafter, a second additional distribution unit module 200C) detachably connected to the first additional distribution unit module 200B.

The basic distribution unit module 200A is connected to the outdoor unit 100 and, in addition, to the first additional distribution unit module 200B. The first additional distribution unit module 200B includes connection parts and refrigerant pipes similar to those of the basic distribution unit module 200A. Therefore, the first additional distribution unit module 200B includes connection parts 230B and 290B connected to other distribution unit modules, as previously described. That is, the distribution unit modules have essentially the same connection structure in which the distribution unit modules are connected to each other, and therefore, the number of distribution unit modules that can be interconnected to form the distribution unit assembly 200 may be varied. However, in reality, it is also understood that the number of distribution unit modules which may be interconnected to form the distribution unit assembly 200 may be determined based on the capacity of the compressor 170 of the outdoor unit 100.

The detailed construction of the second additional distribution unit module 200C is essentially the same as that of the first additional distribution unit module 200B connected to the basic distribution unit module 200A. Therefore, a detailed description of the second additional distribution unit module 200C newly added in this embodiment will not be provided.

In this embodiment, the basic distribution unit module 200A has a single indoor unit connection part 270A connected to an indoor unit. In this case, the pipe structure in the basic distribution unit module 200A may be embodied by removing the indoor unit connection part 270A-2, the liquid state refrigerant branch pipe 241A-2, the electronic expansion valve 260A-2, the liquid state refrigerant connection pipe 265A-2, and the gas state refrigerant branch pipe 277A-2 from the basic distribution unit module set forth with respect to the previous embodiment. Therefore, a detailed description of the basic distribution unit module 200A according to this embodiment including the indoor unit connection part 270A will not be provided.

In the distribution unit modules 200A, 200B, and 200C according to this embodiment, the outdoor unit connection part 250A, the additional connection part 290A (see FIG. 12), the distribution unit connection part 230B, the additional connection part 290BA (see FIG. 12), the distribution unit connection part 230C, and the distribution unit connection part (not shown), which are connected to the outdoor unit 100 and to an adjacent distribution unit module, may have a socket structure.

In the previous embodiment, the respective connection parts employed an enlarged pipe section. In this embodiment, the respective connection parts may be configured in the form of a socket having a short tubular pipe fitting, at opposite ends of which female screws are formed. The socket structure may provide for more simple and easy connection and separation between the respective connection parts compared to the enlarged pipe section in which connection between the respective connection parts is achieved by welding.

As described above, the air conditioning device as embodied and broadly described herein includes distribution unit modules, which are detachably connected to each other so that it is possible to add or remove the distribution unit module(s) as needed. This allows, users to purchase only a number of distribution units necessary to accommodate the required number of indoor units when purchasing an air conditioning system. Additional modular distribution unit(s) maybe purchased when additional indoor unit(s) are needed. Therefore, initial purchase cost may be reduced, and product purchasing options may be expanded. Also, a distribution unit module having fewer indoor unit connection parts may reduce material costs are reduced and increase profit.

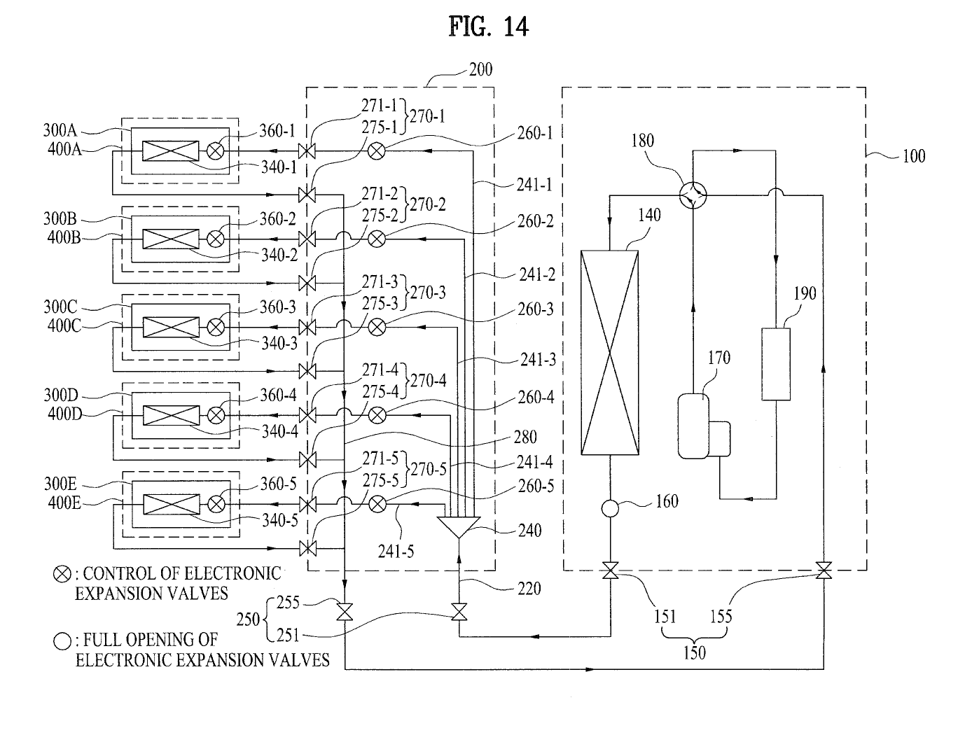

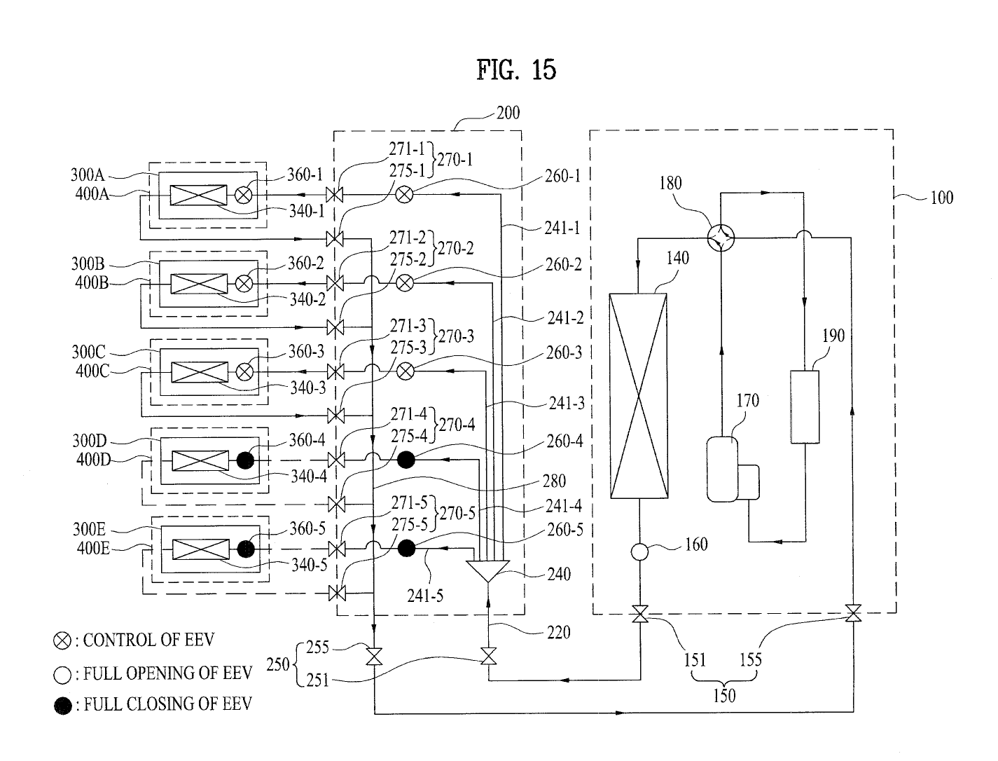

Hereinafter, a flow of refrigerant in an air conditioning device in accordance with another embodiment will be described in detail with reference to FIGS. 14 to 17. It is noted that a distribution unit 200, which will be described below, may refer not only to a single distribution unit but also to a distribution unit assembly including a plurality of distribution unit modules.

FIGS. 14 and 15 are block diagrams illustrating refrigerant flow in a cooling mode of air conditioning device, and in particular, a full cooling mode in which all of the indoor units of the air conditioning device as embodied and broadly described herein are operating. FIG. 15 illustrates a partial cooling mode in which some of the indoor units of the air conditioning device are operating. Simply for ease of discussion, it is assumed that a single outdoor unit 100 is connected to a total of 5 indoor units 300A, 300B, 300C, 300D and 300E via a distribution unit 200, the distribution unit 200 is mounted outside the outdoor unit 100, and not in the outdoor unit 100, and an outdoor unit connection part 250 of the distribution unit 200 and a pipe connection part 150 of the outdoor unit 100 are interconnected via a pair of refrigerant pipes.

In a case in which the distribution unit 200 is mounted in the outdoor unit 100, the outdoor unit connection part 250 of the distribution unit 250 and the pipe connection part 150 of the outdoor unit 100 may be directly connected to each other.

in addition to the compressor 170 and the outdoor heat exchanger 140, the outdoor unit 100 may also include an accumulator 190 for separating a liquid state refrigerant and a gas state refrigerant, a four-way valve 180 for changing a refrigerant flow direction based on operation conditions of the first to fifth indoor units 300A, 300B, 300C, 300D and 300E respectively installed in first to fifth air conditioning spaces 400A, 400B, 4000, 400D and 400E, and an expansion valve 160 for controlling refrigerant flow rate or expanding/decompressing refrigerant.

In FIGS. 14 and 15, arrow directions on the four-way valve 450 indicate operation conditions of the first to fifth indoor units 300A, 300B, 300C, 300D, and 300E, for example, the flow of a refrigerant based on performance of a cooling operation or a heating operation in each of the individual air conditioning spaces 400A, 400B, 400C, 400d and 400E. When a refrigerant flows in the direction of an arrow drawn by a solid line, the air conditioning device is operated in a cooling mode in which the first to fifth air conditioning spaces 400A, 400B, 400C, 400D and 400E are respectively cooled by the first to fifth indoor units 300A, 300B, 300C, 300D and 300E. In the cooling operations of the first to fifth indoor units 300A, 300B, 300C, 300D and 300E, the high-pressure socket 151 of the pipe connection part 150 serves as a socket for supplying a refrigerant that has passed through the compressor, and the low-pressure socket 155 of the pipe connection part 150 serves as a socket for collecting a refrigerant for return to the outdoor unit 100.

The pipe connection part 150 formed by the high-pressure socket 151 and the low-pressure socket 155 may be provided in the outdoor unit housing 110, as previously described, and may be connected to an outdoor side connection part 250 including an outdoor side high-pressure socket 251 and an outdoor side low-pressure socket 255 provided in the distribution unit 200 via detachably mountable connection pipes.

Hereinafter, the flow of refrigerant in the distribution unit 200 will be discussed on the assumption that cooling operations are performed by the first to fifth indoor units 300A, 300B, 300C, 300D and 300E. A refrigerant is compressed by the compressor 170, and the compressed refrigerant is condensed by the outdoor heat exchanger 140. The condensed refrigerant is discharged to the high-pressure socket 151 of the pipe connection part 150 and supplied to the distribution unit 200 via the outdoor side high-pressure socket 251 of the distribution unit 200 connected to the high-pressure socket 151. The refrigerant supplied to the distribution unit 200 is supplied to the indoor unit connection parts 270 provided at the distribution unit 200.

The refrigerant supplied to the distribution unit 200 is branched and supplied to the indoor unit connection parts 270 by the distributor 240 connected to a plurality of branch pipes corresponding to the indoor unit connection parts 270. The refrigerant distributed by the distributor 240 is selectively expanded or controlled in flow rate by first to fifth electronic expansion valves 260-1, 260-2, 260-3, 260-4 and 260-5, which are respectively mounted on first to fifth liquid state refrigerant branch pipes 241-1, 241-2, 241-3, 241-4 and 241-5, and is then supplied to the first to fifth indoor units 300A, 300B, 300C, 300D, and 300E via the first to fifth indoor unit connection parts 270-1, 270-2, 270-3, 270-4 and 270-5 of the distribution unit 200. The auxiliary controller 400 may control the first to fifth electronic expansion valves 260-1, 260-2, 260-3, 260-4 and 260-5 of the distribution unit 200.

The refrigerant supplied to the first to fifth indoor units 300A, 300B, 300C, 300D and 300E is heat-exchanged by respective indoor heat exchangers 340-1, 340-2, 340-3, 340-4 and 340-5 according to cooling loads of the first to fifth air conditioning spaces 400A, 400B, 400C, 400D and 400E, and is then collected and returned to the outdoor unit 100. In a case in which expansion valves 360-1, 360-2, 360-3, and 360-4 are provided in the respective indoor units, the refrigerant may be decompressed or expanded before the refrigerant is supplied to the respective indoor heat exchangers 340-1, 340-2, 340-3, 340-4 and 340-5.

In FIG. 15, the first to third indoor units 300A, 300B and 300C, which are respectively in the first to third air conditioning spaces 400A, 400B,and 400C, are operated in a cooling mode, and the fourth and fifth indoor units 300D and 300E, which are respectively installed in the fourth and fifth air conditioning spaces 400D and 400E, are not operated. In this case, the interruption of the supply of refrigerant to the fourth and fifth indoor units 300D and 300E may be achieved by closing the fourth and fifth electronic expansion valves 260-4 and 260-5. Additional interruption valves may be provided in the respective indoor units, or the interruption valves for selectively interrupting the supply of a refrigerant may be omitted, or the number of the interruption valves may be minimized. Consequently, the distribution unit 200 may distribute refrigerant to the respective indoor units or to collect the refrigerant from the indoor units for return to the outdoor unit 100, and, in addition, may selectively supply or interrupt the flow of refrigerant to selectively operated the indoor units.

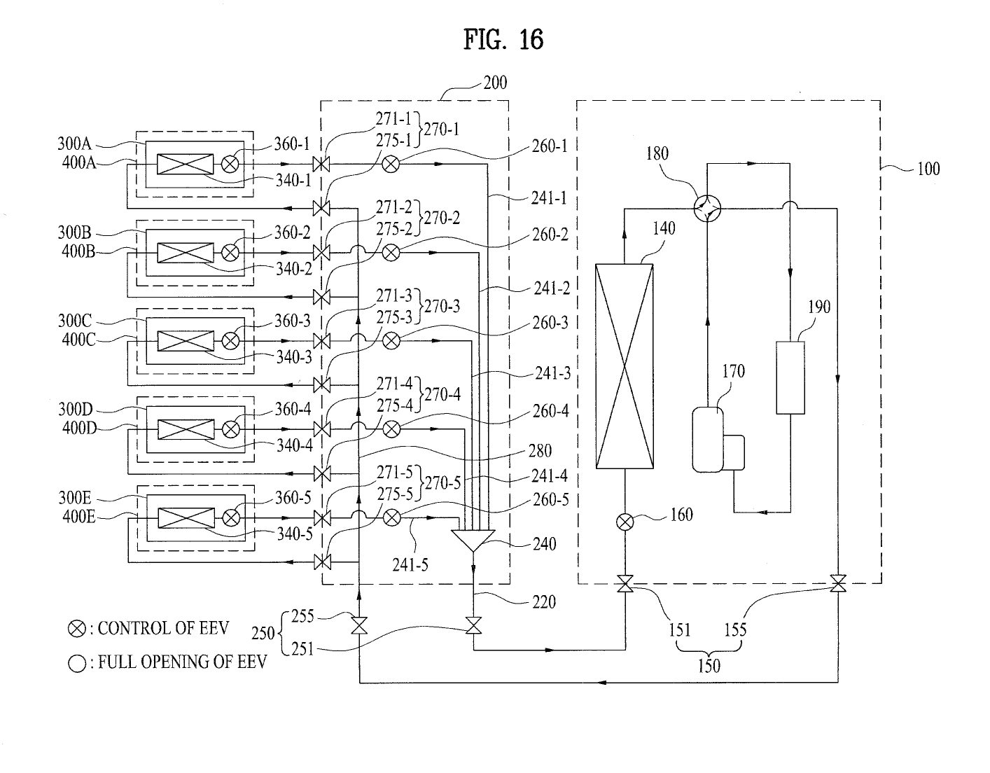

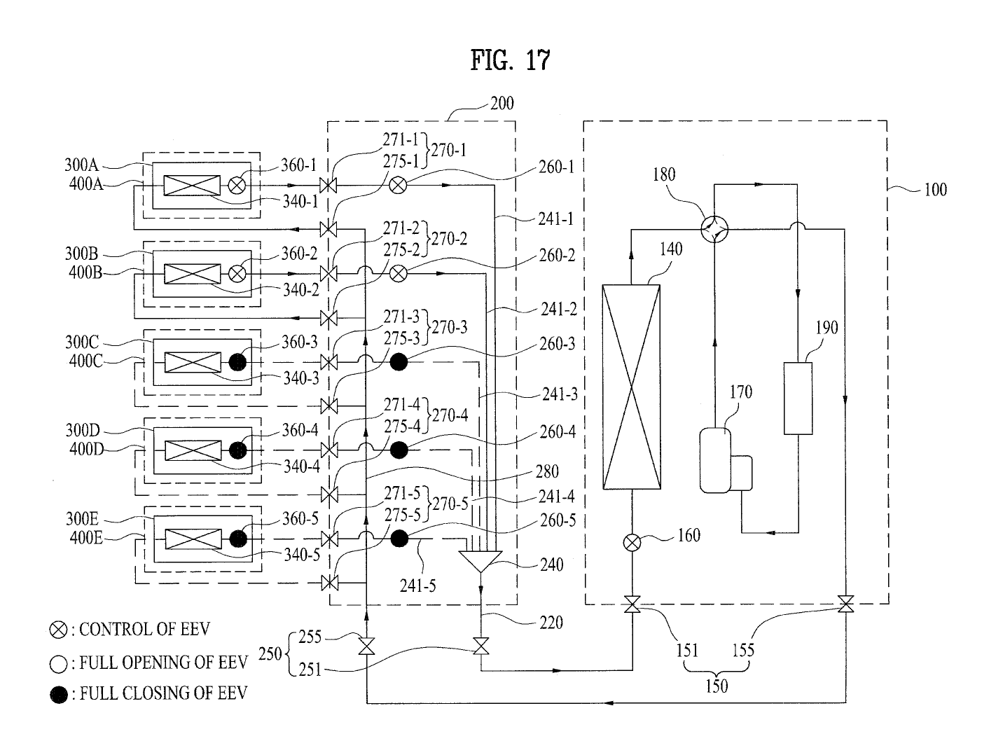

FIGS. 16 and 17 are block diagrams of refrigerant flow in a heating mode of the air conditioning device. FIG. 16 shows a full heating mode in which all of the indoor units are heating respective air conditioning spaces, and FIG. 17 shows a partial heating mode in which some of the indoor units are heating corresponding air conditioning spaces.

In a case in which the first to fifth air conditioning spaces 400A, 400B, 400C, 400D and 400E are heated, the outdoor heat exchanger 140 provided in the outdoor unit 100 may serve as an evaporator, and the indoor heat exchangers provided in the respective indoor units may serve as condensers. In the heating mode, the electronic expansion valves provided in the distribution unit 200 may control the refrigerant flow rate based on air conditioning loads or heating loads of the respective air conditioning spaces.

FIG. 17 shows a state in which the first and second indoor units 300A and 300B are operated in a heating mode, and the third to fifth indoor units 300C, 300D and 300E, are not operated. In this case, the interruption of the supply of refrigerant to the third to fifth indoor units 300C, 300D and 300E may be achieved by closing the third to fifth electronic expansion valves 260-3, 260-4 and 260-5, which are provided in the distribution unit 200, in essentially the same manner as in the previously described cooling mode.

In an outdoor unit, a distribution unit, and an air conditioning device including the outdoor unit and the distribution unit as embodied and broadly described herein, the length of pipes connected between a plurality of indoor units and the outdoor unit is minimized, the air conditioning device is installed in various installation forms, and arrangement efficiency of pipes provided in the distribution unit for interconnecting the indoor units and the outdoor unit is maximized to minimize the volume of the distribution unit.

In an outdoor unit, a distribution unit, and an air conditioning device including the outdoor unit and the distribution unit and embodied and broadly described herein, the distribution unit for interconnecting a plurality of indoor units and the outdoor unit to distribute a refrigerant is configured in a modular structure such that modular distribution units can be detachably connected to each other, and therefore, the distribution units may be added or removed as needed.

In an air conditioning device as embodied and broadly described herein, it is possible to minimize the length of refrigerant pipes connected between a plurality of indoor units and an outdoor unit. Also, it is possible for the air conditioning device to be installed in various installation forms depending upon the conditions of an installation space.

It is also possible to maximize arrangement efficiency of pipes provided in a distribution unit for interconnecting the indoor units and the outdoor unit of the air conditioning device according to the present invention, thereby minimizing the volume of the distribution unit, and to add or remove the distribution unit as needed.

That is, it may not be necessary to purchase a distribution unit that may be connected to more than a necessary number of indoor units, as a modular distribution unit may be added to the system when further indoor units are added. Therefore, an initial purchase and installation cost reduced, and may be options for future system expansion are available.

Distribution unit module having a small number of indoor unit connection parts may reduce material costs and increase profitability.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An air conditioning device, comprising:
at least one indoor unit that performs heat exchange to heat or cool a corresponding space;
an outdoor unit operably coupled to the indoor unit, the outdoor unit including a compressor, an outdoor heat exchanger, and a blowing fan; and
a distribution device detachably installed in the indoor unit, the distribution device comprising:
a distribution device housing;
at least one indoor unit connector extending outward from the distribution device housing and connected to the at least one indoor unit;
a liquid state refrigerant pipe and a gas state refrigerant pipe each having a first end extending outward from the distribution device housing, wherein the distribution device distributes refrigerant from the outdoor unit to the at least one indoor unit and receives refrigerant from the at least one indoor unit.

2. The air conditioning device of claim 1, wherein the distribution device further comprises:
an outdoor unit connector provided at the first ends of the liquid state refrigerant pipe and the gas state refrigerant pipe so as to be connected to the outdoor unit;
a distributor connected to a second end of the liquid state refrigerant pipe so as to distribute refrigerant to the at least one indoor unit connector; and
at least one electronic expansion valve connected to the distributor.

3. The air conditioning device of claim 2, wherein the liquid state refrigerant pipe and the gas state refrigerant pipe are arranged in the distribution device housing in a longitudinal direction thereof of the distribution unit housing, and the outdoor unit connector is provided at the first ends of the liquid state refrigerant pipe and the gas state refrigerant pipe extending outward through a top or a bottom of the distribution device housing.

4. The air conditioning device of claim 3, wherein portions of the liquid state refrigerant pipe and the gas state refrigerant pipe adjacent to the first ends thereof are bent so as to extend in a direction that is different from the longitudinal direction of the distribution device housing.

5. The air conditioning device of claim 3, wherein the liquid state refrigerant pipe and the gas state refrigerant pipe each include an enlarged pipe section, wherein an inner diameter of each enlarged pipe section is greater than a diameter of the corresponding liquid state refrigerant pipe and gas state refrigerant pipe.

6. The air conditioning device of claim 5, wherein the enlarged pipe sections of the liquid state refrigerant pipe and the gas state refrigerant pipe are provided at corresponding heights on their respective pipes, at a portion thereof that is outside of the distribution device housing.

7. The air conditioning device of claim 6, wherein corresponding end portions of the liquid state refrigerant pipe and the gas state refrigerant pipe that extend outward though the top or the bottom of the distribution device housing are bent so as to extend in a direction different from the longitudinal direction of the distribution device housing, and wherein the enlarged pipe sections are located between bent portions of the liquid state refrigerant pipe and the gas state refrigerant pipe and the distribution device housing.

8. The air conditioning device of claim 2, wherein the at least one indoor unit comprises a plurality of indoor units and the at least one indoor unit connector comprises a plurality of indoor unit connectors respectively connected to the plurality of indoor units, and wherein the air conditioning device further comprises a plurality of gas state refrigerant branch pipes branching off from the gas state refrigerant pipe and respectively connected to the plurality of indoor unit connectors at predetermined intervals.

9. The air conditioning device of claim 8, wherein the plurality of indoor unit connectors are arranged along a side of the distribution device housing, and the plurality of gas state refrigerant branch pipes are positioned between the plurality of indoor unit connectors and the gas state refrigerant pipe.

10. The air conditioning device of claim 2, wherein the at least one indoor unit connector comprises a plurality of indoor unit connectors respectively connected to a plurality of indoor units and the at least one electronic expansion valve comprises a plurality of electronic expansion valves, and wherein the air conditioning device further comprises a plurality of liquid state refrigerant branch pipes branching off from the distributor provided at the second end of the liquid state refrigerant pipe and respectively extending to the plurality of electronic expansion valves.

11. The air conditioning device of claim 10, further comprising a plurality of liquid state refrigerant connection pipes that respectively extend from the plurality of electronic expansion valves to the plurality of indoor unit connectors.

12. The air conditioning device of claim 4, wherein the outdoor unit connector comprises:
an outdoor side high-pressure socket; and
an outdoor side low-pressure socket, wherein a height of the outdoor side high-pressure socket is different than a height of the outdoor side low-pressure socket.

13. The air conditioning device of claim 12, wherein the outdoor unit includes a high-pressure socket and a low-pressure socket that are detachably coupled to the outdoor side high-pressure socket and the outdoor side low-pressure socket, respectively.

14. The air conditioning device of claim 13, wherein the high-pressure socket and the low-pressure socket are detachably coupled to the outdoor side high-pressure socket and the outdoor side low-pressure socket in a horizontal direction.

15. The air conditioning device of claim 1, wherein the distribution device comprises a distribution assembly, the distribution assembly comprising:
a primary distribution module having an outdoor unit connection part connected to the compressor and the outdoor heat exchanger of the outdoor unit; and
at least one auxiliary distribution module connected to the primary distribution module.

16. The air conditioning device of claim 15, wherein the at least one auxiliary distribution module comprises a first auxiliary distribution module including a distribution device connector detachably connected to the primary distribution module.

17. The air conditioning device of claim 16, wherein the at least one auxiliary distribution module comprises a second auxiliary distribution module also including a distribution device connector, wherein the distribution device connector provided on the second auxiliary distribution module detachably connects the second auxiliary distribution module to the first auxiliary distribution module.

18. The air conditioning device of claim 16, wherein the primary distribution module includes an auxiliary connector configured to be connected to a distribution device connector of the at least one auxiliary distribution module connected adjacent to the primary distribution module, and the at least one auxiliary distribution module also includes an auxiliary connector configured to be connected to a distribution device connector of another auxiliary distribution module connected adjacent to the at least one auxiliary distribution module.

19. The air conditioning device of claim 18, wherein the primary distribution module and each of the at least one auxiliary distribution modules includes a liquid state refrigerant pipe and a gas state refrigerant pipe, the liquid state refrigerant pipes and the gas state refrigerant pipes of the primary and auxiliary distribution modules being respectively connected to each other by respective distribution device connectors and auxiliary connectors, and the liquid state refrigerant pipes and the gas state refrigerant pipes of the primary distribution module and each of the at least one auxiliary distribution modules are connected to the outdoor unit via the outdoor unit connector of the primary distribution module.

20. The air conditioning device according to claim 18, wherein the auxiliary connectors of the primary distribution module and each of the at least one auxiliary distribution module are selectively opened and closed by blocking members.

21. The air conditioning device of claim 18, wherein the distribution device connector or the auxiliary connector has a socket structure.

22. The air conditioning device of claim 15, wherein the distribution assembly is formed by connecting the primary distribution module and each of the at least one auxiliary distribution modules to each other in a stacked structure.

23. An outdoor unit of an air conditioning device, comprising:
a compressor that compresses refrigerant;
an outdoor heat exchanger that selectively condenses or evaporates the refrigerant based on an operating condition of at least one indoor unit operably coupled to thereto;
a fan that blows air that has undergone heat-exchange with the refrigerant;
an outdoor unit housing that houses the compressor, the outdoor heat exchanger, and the fan; and
a distribution device, comprising:
at least one indoor unit connector that is connected to the indoor unit; and
a distribution device housing that is detachably installed within the outdoor unit housing.

24. A distribution assembly, comprising:
a primary distribution module, comprising:
an indoor unit connector configured to be connected to at least one indoor unit of an air conditioning device;
an outdoor unit connector configured to be connected to an outdoor unit of the air conditioning device; and
a primary housing that defines an exterior of the primary distribution module; and
at least one auxiliary distribution module, comprising:
an indoor unit connector configured to be connected to one or more corresponding indoor units of the air conditioning device;
a distribution connector configured to be connected to the primary distribution module; and
an auxiliary housing that defines an exterior of the at least one auxiliary distribution module.

25. The distribution assembly of claim 24, wherein the distribution device connector of one auxiliary distribution module of the at least one auxiliary distribution module is configured to be connected to another auxiliary distribution module.

26. The distribution assembly of claim 25, wherein the primary distribution unit module and the at least one auxiliary distribution module each include an auxiliary connector configured to be connected to a distribution device connector of an adjacent auxiliary distribution module successively connected thereto.

27. The distribution assembly of claim 26, wherein the primary distribution module and each of the at least one auxiliary distribution modules has a liquid state refrigerant pipe, a gas state refrigerant pipe, and electronic expansion valves provided therein, a number of which corresponds to a number of indoor unit connectors.

28. The distribution assembly of claim 27, wherein the primary distribution module and each of the at least one auxiliary distribution modules further comprises liquid state refrigerant branch pipes branching off from the liquid state refrigerant pipe to respective electronic expansion valves and liquid state refrigerant connection pipes connected between the electronic expansion valves and the indoor unit connectors.

29. The distribution assembly of claim 27, wherein the primary distribution module and each of the at least one auxiliary distribution modules further comprises gas state refrigerant branch pipes branching off from the gas state refrigerant pipe to the respective indoor unit connectors.

30. A distribution assembly for an air conditioning device including an outdoor unit connected to a plurality of indoor units, the distribution assembly comprising:
a primary distribution module directly connected to the outdoor unit so as to receive refrigerant directly from the outdoor unit and transfer refrigerant directly to the outdoor unit; and
a plurality of auxiliary distribution modules respectively connected to the plurality of indoor units,
wherein a first of the plurality of auxiliary distribution modules is directly connected to the primary distribution module so as to receive refrigerant from the outdoor unit via the primary distribution module and to transfer refrigerant to the outdoor unit via the primary distribution module, and
wherein a remainder of the plurality of auxiliary distribution modules are sequentially connected to the first of the plurality of auxiliary distribution modules so as to receive refrigerant from the outdoor unit via the primary distribution module, the first of the plurality of auxiliary distribution modules and any other intervening auxiliary distribution modules and to transfer refrigerant to the outdoor unit via the any other intervening auxiliary distribution modules, the first of the plurality of auxiliary distribution modules and the primary distribution module.
